(19) United States
(12) Patent Application Publication
(10) Pub. No.: US 2002/0055053 A1
(43) Pub. Date: May 9, 2002

(54) Toner

(76) Inventors: Takashige Kasuya, Shizuoka-ken (JP); Hirohide Tanikawa, Shizuoka-ken (JP); Hiroshi Yusa, Tokyo (JP); Yoshihiro Ogawa, Shizuoka-ken (JP); Katsuhisa Yamazaki, Numazu-shi (JP); Ryota Kashiwabara, Numazu-shi (JP)

Correspondence Address: FITZPATRICK CELLA HARPER & SCINTO, 30 ROCKEFELLER PLAZA, NEW YORK, NY, 10112, US

(21) Appl. No.: 09/946,498

(22) Filed: Sep. 6, 2001

(30) Foreign Application Priority Data
Sep. 6, 2000 (JP) 269632/2000

(51) Int. Cl. G03G 9/097; G03G 9/09

(52) U.S. Cl. 430/108.23; 430/109.4

(57) ABSTRACT

A toner showing quick chargeability and stable chargeability in a high humidity environment is provided by a combination of a specific polyester binder resin and a specific azo iron compound. The polyester binder resin has an acid value (Av) of 0.5 to 30 mgKOH/g and a hydroxyl value (OHv) of 1 to 50 mgKOH/g giving a ratio (Av/OHv) therebetween satisfying: 0.05≦Av/OHv≦2.0. The azo iron compound is preferably an iron complex (salt) including as a ligand a mono-azo compound formed by diazo coupling between a 2-aminophenol (derivative) and an alkyl-substituted naphthol (derivative).

### FIELD OF THE INVENTION AND RELATED ART

The present invention relates to a toner for use in an image forming method, such as electrophotography or electrostatic recording, for developing an electrostatic latent image, or in an image forming method, such as toner jetting.

Many of monoazo dye metal complex used as charge control agents for toners are poor in stability and are liable to cause decomposition or denaturation, thus losing initial charge control characteristic, when subjected to mechanical friction or impact, a change in temperature or humidity condition, electrical impact or light irradiation. Further, even monoazo dye metal complexes having a practical level of charge-imparting ability are liable to leave problem in its stability and are liable to contain much chemical impurities not having a charge controlling ability depending on fluctuation of production conditions, thus leaving problems regarding the stability and reliability of qualities.

Monoazo dye metal complex salt compounds disclosed in JP-A 2-35465, JP-B 7-27283 and JP-A 9-169919 are excellent in respect of tribo-electrification performance but have not yet succeeded in realizing a stable developing performance regardless of environment change, lapse of time, or condition for use.

In recent years, electrophotographic apparatus are used not only as copying machines for reproducing originals, but also as printers for computer outputs and facsimile apparatus. In view of increasing demands for compact and high-speed machines, a toner exhibiting excellent developing performances is required. For complying with such demands, however, improvements have to be achieved in several items of toner performances, such as transferability, low-temperature fixability, anti-offset characteristic, and continuous image forming performances for a long period in a high temperature/high humidity environment.

Particularly, a toner adapted for use in a high-speed image forming apparatus has to be surely transferred from a developing sleeve to a photosensitive member, such as a photosensitive drum for development, and from the photosensitive drum to paper, even at a high printing speed. As a method for providing an increased transfer efficiency, it has been known to make a toner (particle) shape closer to a sphere.

A toner (particle) having a shape close to a sphere and thus having an angle-free smooth surface has a small powdery contact area with the developing sleeve and the photosensitive drum, and thus shows a small attachment force onto these members, so that it can exhibit a good transfer efficiency.

However, a toner having a shape closer to a sphere tends to exhibit a larger increase in triboelectric charge and is liable to exhibit a large difference in charge between a newly supplied toner and a toner already contained in the apparatus, thus causing an image density difference (ghost), e.g., in a high-speed apparatus where frequency of friction on the developing sleeve is increased. Particularly, at a later stage in a continuous image formation in a high temperature/high humidity environment, a chargeability difference between an old toner (remaining on a developing sleeve and a new toner (freshly supplied to the developing sleeve)) is liable to result in a positive ghost of leaving a trace of density pattern of a previously formed image in a subsequent image. For example, at the time of forming a uniform halftone after forming a black-stripe pattern, a portion of the halftone area formed after the black image is formed at a slightly higher image density and a portion of the halftone area formed after a white image is formed at a slightly lower image density (e.g., as shown in FIG. 7).

On the other hand, a strong desire is present for higher speed and economization of energy of the apparatus, and a toner showing excellent low-temperature fixability is desired therefor. It is known that a polyester-based resin exhibits a better fixability than a polystyrene-based resin as a toner resin. However, a polyester-based resin has a drawback that it is liable to have inferior chargeability in a high humidity environment because of many polar groups. This drawback is particularly pronounced in a non-contact development scheme using a developer-carrying member equipped with an elastic blade.

JP-B (Japanese Patent Publication) 07-97242 has proposed a toner using a polyester resin containing a carboxylic acid component and having specified acid and hydroxyl values; JP-B (Japanese Patent No.) 2963161 has disclosed a toner containing a salicylic acid derivative and having specified acid and hydroxyl values; and JP-B 2973362 has disclosed a toner having a specified acid value and a specified ratio of acid value to hydroxyl value. These toners are not yet sufficient regarding the charging stability, developing performance in high humidity environment, and stability of continuous image forming performances.

Further, JP-A 5-27479 has disclosed a toner having specified hydroxyl and acid values and comprising toner particles to the surface of which polymer fine particles have been attached, as a toner for improving the filming and preventing blade turn-over. This is however not sufficient for high-speed image forming performances and image forming performances in high temperature/high humidity environment.

### SUMMARY OF THE INVENTION

A generic object of the present invention is to provide a toner having solved the above-mentioned problems.

A more specific object of the present invention is to provide a toner capable of being quickly charged in a high-speed image forming apparatus in a high temperature/high humidity environment and exhibiting a good developing performance for a long period.

Another object of the present invention is to provide a toner resulting in images of high image qualities, inclusive of halftone reproducibility and dot reproducibility.

According to the present invention, there is provided a toner, comprising: at least a binder resin, a colorant and an organometallic compound; wherein

said organometallic compound is an azo iron compound produced from a mono-azo compound of Formula (A) below:

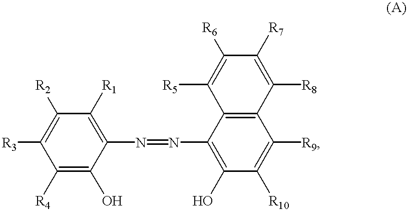

wherein R1-R10 independently denote hydrogen, halogen or alkyl with the proviso that one or more adjacent pairs among R1-R10 can be connected to form an aromatic or alicyclic ring, and at least one of R5-R10 is alkyl,

the binder resin comprises a polyester resin and has acid value (Av) of 0.5 to 30 mgKOH/g and a hydroxyl value (OHv) of 1 to 50 mgKOH/g giving a ratio (Av/OHv) therebetween satisfying a relationship of:

0.05≦Av/OHv≦2.0.

It is preferred that the azo iron compound is one represented by Formula (B) below:

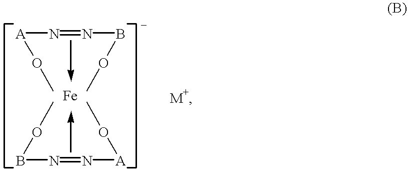

wherein A and B denote o-phenylene and 1,2-naphthylene, respectively, each capable of having a substituent of halogen or alkyl with the proviso that the naphthylene residues have at least one alkyl group; and M⁺ denotes a cation of hydrogen, alkali metal, ammonium or organic ammonium.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a flow chart for illustrating an example of toner production process adapted to production of a toner according to the invention.

FIG. 2 illustrates an example of apparatus system for practicing such a toner production process.

FIG. 3 is a schematic sectional view of a mechanical pulverizer used in a toner pulverization step.

FIG. 4 is a schematic sectional view of a D-D′ section in FIG. 3.

FIG. 5 is a perspective view of a rotor contained in the pulverizer of FIG. 3.

FIG. 6 is a schematic sectional view of a multi-division pneumatic classifier used in a toner classification-step.

FIG. 7 is an illustration of positive ghost.

FIG. 8 is an illustration of a method for measurement of transfer efficiency.

FIG. 9 is a graph showing a relationship between proportion of toner particles of circularity (Ci)≧0.95 and weight-average particle size (D4) of toners.

### DETAILED DESCRIPTION OF THE INVENTION

As a result of our study on toner ingredients, it has been found possible to provide a toner with excellent performances in a high-speed image forming apparatus by using a specific azo iron compound in combination with a polyester resin providing a toner binder resin with a specific acid value and a specific ratio of acid value/hydroxyl value.

The toner of the present invention includes an azo iron compound produced from a mono-azo compound of Formula (A) below:

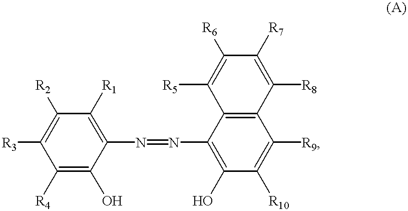

wherein R1-R10 independently denote hydrogen, halogen or alkyl with the proviso that one or more adjacent pairs among R1-R10 can be connected to form an aromatic or alicyclic ring, and at least one of R5-R10 is alkyl.

The azo iron compound used in the present invention is an azo iron compound produced from a mono-azo compound having two hydroxyl groups capable of bonding with iron atom and represented by the above-mentioned Formula (A). The azo iron compound is a compound formed by coordination of the hydroxyl groups onto iron atom and may assume a form of an iron complex, an iron complex salt or a mixture of these.

A characteristic of the azo iron compound is that at least one of R5-R10 is an alkyl group, thereby showing an enhanced dispersibility and an excellent charge control performance. It is preferred to use a mono-azo compound wherein the alkyl group has 4-12 carbon atoms, more preferably 6-10 carbon atoms. By including an alkyl group having a certain length or longer, it is presumed that the azo iron compound can be prevented from falling-off thereof from toner particles and can contribute to quick and high chargeability of the toner due to mutual interaction between its molecules. It is further preferred that the alkyl group has a form of tertiary alkyl group which includes two or more alkyl groups in its side chains. By including such a tertiary alkyl group having side chains, the azo iron compound is provided with a bulky three-dimensional structure and a stable electronic structure of the compound as a whole, thereby easily maintaining its charging performance. Further, by using the azo iron compound with the polyester resin having specified acid and hydroxyl values, it becomes possible to provide a toner not only with improved chargeability but also with improved flowability and remarkably improved halftone-image forming performance.

It is particularly preferred to use an azo iron compound having a tertiary alkyl group including 3 or more side alkyl groups so as to exhibit a high chargeability. As a result, the azo iron compound can assume a structure most stabilizing acquired charges because of hyper-conjugation of substituent connected to the naphthalene ring. By attachment of a tertiary alkyl group including electron-donative side alkyl groups, the electrone density of C═C double bonds is increased to play an important role for charge retention for a long period. An azo iron compound having an alkyl group satisfying the above-conditions at its R7 position can assume a most stable electron structure and a bulky thee-dimensional structure, whereby its chargeability can be well retained even in a high temperature/high humidity environment. Further, because of the presence of the alkyl group, the dispersibility of the compound in the resin is improved to alleviate fog in a low temperature/low humidity environment.

It is further preferred that at least one of R1-R4 in the mono-azo compound (A) is halogen. By introducing such an electron-attractive group, the electron structure of the resultant azo iron compound is stabilized to exhibit an enhanced charge-imparting ability.

On the other hand, an azo iron compound formed from a mono-azo compound of Formula (A) including no alkyl group at any of R5-R10 positions results in a toner, which is liable to lose its chargeability and result in a lower image density, particularly at a time of high-speed image formation in a high temperature/high humidity environment.

The azo iron compound thus formed from a mono-azo compound of Formula (A) may have a structure represented by one of Formulae (B), (C) and (D) shown below. In order to provide a good toner chargeability even in a high temperature/high humidity environment, it is preferred to use an azo iron compound having a structure represented by Formula (B) wherein M⁺ is particularly preferably a sodium iron so as to exhibit an excellent charge stability.

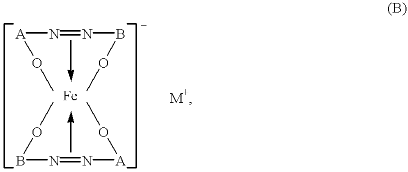

In the Formula (B), A and B denote o-phenylene and 1,2-naphthylene, respectively, each capable of having a substituent of halogen or alkyl with the proviso that the naphthylene residues have at least one alkyl group; and M⁺ denotes a cation of hydrogen, alkali metal, ammonium or organic ammonium.

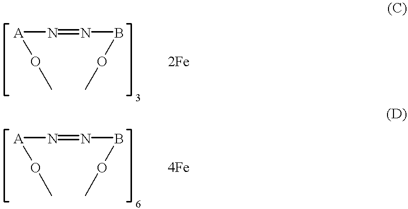

In the above Formulae (C) and (D), A and B are respectively the same as in Formula (B) above.

The mono-azo compound of Formula (A) may be formed through an ordinary diazo coupling reaction by appropriately selecting starting aromatic amines and phenolic compounds.

Examples of mono-azo compounds (Compounds 1 to Compounds 28) preferably used for producing the azo iron compound used in the present invention may be enumerated hereinbelow.

[chemical structure]

The azo iron compound having a structure as represented by the Formulae (B)-(D) may be obtained by reacting the above-mentioned mono-azo compound of Formula (A) with an iron-source metalation agent in water and/or an organic solvent, preferably in an organic solvent.

The reaction product thus-formed in an organic solvent may generally be recovered through a post-treatment process wherein the product is dispersed in an appropriate amount of water, filtered out as a precipitate, washed with water and dried; or the product is precipitated in the solvent, filtered out, washed with water and dried. The former process is preferred in order to provide a good dispersibility in the polyester resin having specified acid and hydroxyl values, thereby providing a toner showing long-term charging stability.

Examples of the organic solvent for the above-mentioned metalation reaction may include: alcohol, ether and glycol solvents, such as methanol, ethanol, propanol, isopropyl alcohol, butanol, ethylene glycol monomethyl ether, ethylene glycol monomethyl ether, ethylene glycol monoethyl ether, propylene glycol monomethyl ether, ethylene glycol dimethyl ether (diglyme), ethylene glycol diethyl ether, triethylene glycol dimethyl ether (triglyme), tetraethylene glycol dimethyl ether (tetraglyme), ethylene glycol and propylene glycol; and other water-soluble organic solvents inclusive of aprotonic solvents, such as N,N-dimethylacetoamide, N-methyl-2-pyrrolidone and dimethyl sulfoxide. Among the above, it is particularly preferred to use at least one of ethylene glycol monomethyl ether (methyl cellosolve), ethylene glycol monoethyl ether (ethyl cellosolve), and ethylene glycol.

Such an organic solvent may be used in an appropriate amount not particularly restricted but may for example be 2-5 times by weight that of the mono-azo compound as the ligand.

Suitable examples of the iron-source metalation agent may include: ferric chloride, ferric sulfate, and ferric nitrate. Such an ironing agent may generally be used in an amount of ⅓ to ⅔ equivalent of iron per mol of the mono-azo compound.

The azo iron compound thus-obtained and used as a charge control agent can be used together with a known charge control agent as described in the section of the related art. Examples of such a known charge control agent may include: other organic metal complexes, metal salts and chelate compounds; more specifically, other monoazo metal complexes, acetylacetone metal complexes, hydroxycarboxylic acid metal complexes, polycarboxylic acid metal complexes, and polyol metal complexes. Other examples may include: carboxylic acid derivatives, such as carboxylic acid metal salts, carboxylic acid anhyrides and esters; aromatic compound condensates; and phenol derivatives, such as bisphenols and calixarenes.

Another essential characteristic of the toner according to the present invention is the use of a polyester-based resin having specified acid and hydroxyl values as a toner binder resin.

As a result of our study for further enhancing the chargeability and quick developing performance-exhibiting characteristic by using the above-mentioned azo iron compound, it has been found most effective to use a polyester resin having specified acid and hyroxyl values as a toner binder resin in order achieve the object of the present invention at a higher level.

More specifically, the toner of the present invention comprises, as a toner binder resin, a polyester resin having an acid value (Av) of 0.5-30 mgKOH/g and a hydroxyl value (OHv) of 1 to 50 mgKOH/g giving a ratio (Av/OHv) therebetween satisfying:

0.05≦Av/OHv≦2.0.

If the acid value is below 0.5 mgKOH/g or the hydroxyl value is below 1 mgKOH/g, the quick chargeability characteristic of the resultant toner is impaired. This is because as a result of a lower acid or hydroxyl value, the content at the toner particle surfaces of the azo iron compound is lowered. On the other hand, if the acid value exceeds 30 mgKOH/g or the hydroxyl value exceeds 50 mgKOH/g, the toner performance in a high temperature/high humidity environment is impaired. This is because the moisture absorptivity of the toner particle surfaces is extremely increased to adversely affect the charge-retention characteristic given by the azo iron compound of the present invention.

Further, if the ratio Av/OHv exceeds 2.0, the resultant toner is liable to be excessively charged and exhibit lower fog-prevention effect in a low temperature/low humidity environment. This is presumably because as a result of excessive presence of acid groups relative to hydroxyl groups, the polarization (or ionization) of the azo iron compound is promoted to result in excessive charge.

On the other hand, if the ratio Av/OHv is below 0.05, the resultant toner is inferior in quick chargeability characteristic and chargeability in a high humidity environment. This is presumably because the polarization (or the ionization) of the azo iron compound is obstructed thereby.

It is further preferred that the polyester resin shows an acid value (Av) of 0.5 to 20 mgKOH/g, a hydroxyl value (OHv) of 5 to 40 mgKOH/g, and a ratio Av/OHv satisfying 0.05≦Av/OHv≦1.0.

It is still further preferred that the polyester resin shows an acid value (Av) of 0.5 to 10 mgKOH/g, a hydroxyl value (OHv) of 10 to 40 mgKOH/g, and a ratio Av/OHv satisfying 0.05≦Av/OHv≦1.0.

As another aspect, it is preferred that the total of acid value (Av) and hydroxyl value satisfies 15≦Av+OHv≦70, more preferably 20≦Av+OHv≦60.

If Av+OHv is below 15, the resultant toner is liable to show a lower chargeability, and above 70, the toner is liable to show inferior performances after standing in a high temperature/high humidity environment.

The acid value (Av) and hydroxyl value (OHv) of a resin referred to herein are based on values measured in the following manner. For a toner sample, the additives other than the binder resin (polymer component) are removed to obtain a resinous sample, or the content thereof is measured in advance for calculation of acid and hydroxyl values of the polymer component.

<Acid Value>

The basic operation is according to JIS K-0070.

1) A toner or a binder resin is pulverized, and 0.5-2.0 g of the pulverized sample is accurately weighed to provide a sample containing W (g) of resin component.

2) The sample is placed in a 300-ml beaker, and 150 ml of a toluene/ethanol (4/1) mixture liquid is added thereto to dissolve the sample.

3) The sample solution is (automatically) titrated with a 0.1 mol/liter-KOH solution in ethanol by means of a potentiometric titration apparatus (e.g., “AT-400 (win workstation)” with an “ABP-410” electromotive burette, available from Kyoto Denshi K.K.).

4) The amount of the KOH solution used for the titration is recorded at S (ml), and the amount of the KOH solution used for a blank titration is measured and recorded at B (ml).

5) The acid value Av is calculated according to the following equation:

Acid value Av (mgKOH/g)={(S−B)×f×5.61}/W,

wherein f denotes a factor of the 0.1 mol/liter-KOH solution.

<Hydroxyl Value>

The basic operation is also according to JIS K-0070.

1) A toner or a binder resin is pulverized, and 0.5-2.0 g of the pulverized sample is accurately weighed in a 200 ml-flat-bottomed flask to provide a sample containing W (g) of resin component.

2) 5 ml of an acetylacting agent (prepared by dissolving 25 g of acetic anhydride in pyridine to provide a total volume of 100 ml) is added to the flask containing the sample.

3) A small funnel is placed at the opening of the flask, and the flask is dipped in a depth of ca. 1 cm in a glycerin bath at 95-100° C. At this time, the neck of the flask is covered with a round-bored disk of cardboard so as not to heat the neck of the flask by the heat from the glycerin bath.

4) After 1 hour, the flask is taken out of the glycerin bath and left for cooling. Then, 1 ml of water is added through the funnel and the flask is shaked to decompose the acetic anhydride.

5) For completing the decomposition, the flask is again heated for 10 min. on the glycerin bath, and after being cooled, the walls of the funnel and the flask are washed with 5 ml of ethanol.

6) The content of the flasks is titrated with a 0.5 mol/l-KOH/EtOH solution with several drops of phenolphthalein solution as an indicator, until an end point determined by continuation for 30 sec. of the purple color of the indicator.

7) A blank test is performed by repeating the above-mentioned steps 2) to 6) without adding the sample.

8) In case where the sample is not readly dissolved, a small amount of pyridine, or xylene or toluene, may be added to promote the dissolution.

The hydroxyl vale (OHv (mgKOH/g)) is calculated according to the following equation:

OHv(mgKOH/g)=((B−C)×f×28.05)/S+D

B: amount of the 0.5 ml/l-KOH/EtOH solution (ml) used in the blank test.

C: amount of the 0.5 mol/l-KOH/EtOH solution (ml) used in the sample test.

f: factor of the 0.5 mol/l-KOH/EtOH solution (−)

S: sample weight (g)

D: acid value (mgKOH/g)

As for chemical composition, the polyester resin used in the present invention may have a composition as follows.

Examples of dihydric alcohol component may include: ethylene glycol, propylene glycol, 1,3-butanediol, 1,4-butanediol, 2,3-butanediol, diethylene glycol, triethylene glycol, 1,5-pentanediol, 1,6-hexanediol, neopentyl glycol, 2-ethyl-1,3-hexanediol, hydrogenated bisphenol A, and bisphenol derivatives represented by the following formula (E):

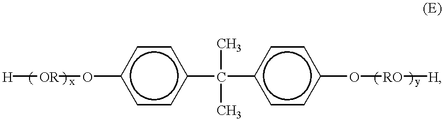

wherein R denotes an ethylene or propylene group, x and y are independently an integer of at least 0 with the proviso that the average of x+y is in the range of 0-10; diols represented by the following formula (2):

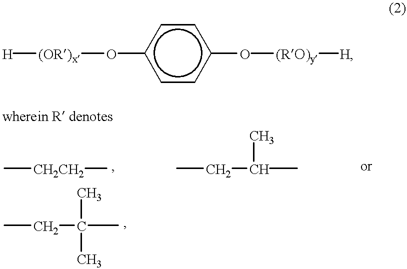

and x′ and y′ are independently an integer of at least 0 with the proviso that the average of x′+y′ is in the range of 0-10.

Examples of a dibasic acid may include: benzenedicarboxylic acids and anhyrides and lower alkyl esters thereof, such as phthalic acid, terephthalic acid, isophthalic acid, and phthalic anhydride; alkyldicarboxylic acids, such as succinic acid, adipic acid, sebacic acid, and azelaic acid, and their anhydrides and lower alkyl esters thereof; and unsaturated dicarboxylic acids, such as fumaric acid, maleic acid, citraconic acid and itaconic acid, and their anhydrides and lower alkyl esters thereof.

It is preferred to include a polycarboxylic acid and/or a polyhydric alcohol having three or more functional groups functioning as a crosslinking component.

Examples of the polyhydric alcohol having at least three hydroxyl groups may include: sorbitol, 1,2,3,6-hexanetetrol, 1,4-sorbitan, pentaerythritol, dipentaerythritol, tripentaerythritol, sucrose, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxybenzene.

Examples of the polycarboxylic acid having at least three carboxyl groups may include polycarboxylic acids and derivatives thereof inclusive of: trimellitic acid, pyromellitic acid, 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, tetra(methylenecarboxyl)methane, 1,2,7,8-octanetetracarboxylic acid, empole trimmer acid, and anhydrides and lower alkyl esters of these; and tetracarboxylic acids represented by Formula (G) below and, anhydrides and lower alkyl esters thereof:

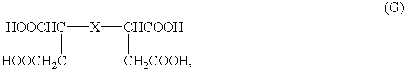

wherein X denotes an alkylene gorup or alkenylene group having 5-30 carbon atoms and having at least one side chain having at least 3 carbon atoms.

The polyester resin may preferably comprise 40-60 mol. %, more preferably 45-55 mol. %, of alcohol, and 60-40 mol. %, more preferably 55-45 mol. % of acid.

It is preferred to include the polyhydric alcohol and/or polybasic carboxylic acid having at least 3 functional groups in a proportion of 2-40 mol. % of the total alcohol and acid components, so as to provide a toner having an increased elasticity and improved anti-high-temperature offset characteristic and continuous image forming performance.

The polyester resin used in the present invention may be produced through ordinary polycondensation.

The binder resin for constituting the toner of the present invention can include another resin in addition to the above-mentioned polyester resin in a proportion not impairing the effect of the present invention, i.e., in a proportion of at most 40 wt. %, as far as the resultant binder resin satisfies the above-mentioned specific acid and hydroxyl values. As such another resin, it is possible to use, e.g., a vinyl resin or an epoxy resin in a form of a mixture with or in a composite form with the polyester resin.

The effect of the combination of the azo iron compound and the polyester having specified acid and hydroxyl values is varied depending on the polarity and the amount of and ratio between the functional groups (acid group and hydroxyl group). Accordingly, it is considered that the varying effect is attributable to changes in chargeability by the concentration and dispersion state at the toner particle surfaces and orientation state of the azo iron compound, and further by the interaction of the azo iron compound with the polar group and main-chain ester bond of the polyester resin.

It is known that a polyester resin is generally liable to cause moisture absorption and exhibit inferior chargeability in a high humidity environment. On the other hand, a toner using a polyester resin can provide a good combination of fixability and storage stability and exhibit excellent low-temperature fixability. In a preferred form of the azo iron compound, an alkyl group is attached to the naphthalene ring, so as to increase the hydrophobicity of the charging site by the presence of the toner particle surface, thereby preventing the inferior chargeability attributable to the polyester resin. An alkyl group having an appropriately large length and an appropriately branched structure is preferred for lowering the surface tension and increasing the hydrophobicity.

The combination of the azo iron compound and the polyester resin adopted in the present invention is effective for providing a toner with suppressed scattering during development, transfer and fixation, thus resulting in images excellent in dot reproducibility and gradation and uniformity of halftone images.

A toner is conveyed to a developing sleeve by a stirring blade in a developer vessel and regulated to a constant layer thickness by a blade on the developing sleeve, whereby the toner is tribo-electrically charged through friction with the blade. At this time, if the toner is not provided with a charge exceeding a certain level, the total amount of the toner transferred from the developing sleeve to the photosensitive drum is decreased to consequently result in developing failure due to a lowering in image density printed on paper. For example, when a toner is produced through pulverization by use of a conventional jet air stream pulverizer wherein powdery feed is caused to impinge on an impinging member to be pulverized under an impact force caused at that time, the resultant toner particles are liable to have coarse and angular shapes in some cases. In the case of a magnetic toner production, the pulverization is frequently caused at the site rich in magnetic iron oxide fine powder, so that toner particles are liable to have much magnetic iron oxide powder. As a result, toner particles imparted with a certain charge are liable to lose the charge as the function of the magnetic iron oxide as the charge leakage site. Further, charge is liable to be concentrated at irregularly broken angles etc. of such angular toner particles, thus resulting in charging irregularity and a lowering in dot reproducibility.

Thus, according to our study, it is preferred to provide a toner having specified level of circularity from toner ingredients including the above-mentioned azo iron compound and polyester resin even if it is produced through the pulverization process, in order to obviate the above-mentioned difficulties of angular toner particles, thereby providing further improved dot reproducibility and high-definition halftone images with excellent gradation and uniformity.

In the present invention, a circularity (Ci) is used as a convenient parameter for quantitatively indicating a particle shape based on values measured by using a flow-type particle image analyzer (“FPIA-1000”, available from Toa Iyou Denshi K.K.). For each measured particle, a circularity Ci is calculated according to equation (1) below, and an average circularity Cav. is calculated by dividing the total of circularities (Ci) of all the measured particles with the number of particles as shown in equation (7) below.

Circularity Ci=L₀/L (1)

wherein L represents a peripheral length of a projection image (two-dimensional image) of an individual particle, and L₀ represents a peripheral length of a circle giving an identical area as the projection image.

$$Average circularity Cav = {\sum }_{i = 1}^{m} Ci / m \qquad ( 7 )$$

wherein m represents a number of measured particles.

A circularity standard deviation SDc may be determined according to equation (8) below:

$$SDc = {( {\sum }_{i = 1}^{m} {( Cav - Ci )}^{2} / m )}^{1 / 2} . \qquad ( 8 )$$

As is understood from the above equation (1), a circularity Ci is an index showing a degree of unevenness of a particle, and a perfectly spherical particle gives a value of 1.00, and a particle having a more complicated shape gives a smaller value. Further, a circularity standard deviation SDc is an index of fluctuation of circularity, and a smaller value represents a smaller fluctuation.

In the flow-type particle image analyzer (“FPIA-1000”) used herein, for convenience of calculation, an actual calculation is automatically performed according to the following scheme: that is, circularities (Ci) of individual particles are classified into 61 divisions by an increment of 0.010 within a circularity range of 0.400-1.000, i.e., 0.400-below 0.410, 0.410-below 0.420, . . . 0.990-below 1.000, and 1.000. Then, an average circularity Cav is determined based on central values and frequencies of the respective divisions. However, an error introduced by the convenient calculation is very small and substantially negligible from the value obtained by strictly applying above-mentioned equations.

For an actual measurement of circularity by using the FPIA-measurement, 0.1-0.5 ml of a surfactant (preferably an alkylbenzenesulfonic acid salt) as a dispersion aid is added to 100 to 150 ml of water from which impurities have been removed, and ca. 0.1-0.5 g of sample particles are added thereto. The resultant mixture is subjected to dispersion with ultrasonic waves (50 kHz, 120 W) for 1-3 min. to obtain a dispersion liquid containing 12,000-20,000 particles/μl (i.e., a sufficiently high particle concentration for ensuring a measurement accuracy even at a high cut percentage), and the dispersion liquid is subjected to measurement of a circularity distribution with respect to particles having a circle-equivalent diameter (C.E.D.) in the range of 0.60 μm to below 159.21 μm by means of the above-mentioned flow-type particle image analyzer.

The details of the measurement is described in a technical brochure and an attached operation manual on “FPIA-1000” published from Toa Iyou Denshi K.K. (Jun. 25, 1995) and JP-A 8-136439 (U.S. Pat. No. 5,721,433). The outline of the measurement is as follows.

A sample dispersion liquid is caused to flow through a flat thin transparent flow cell (thickness=ca. 200 μm) having a divergent flow path. A strobe and a CCD camera are disposed at mutually opposite positions with respect to the flow cell so as to form an optical path passing across the thickness of the flow cell. During the flow of the sample dispersion liquid, the strobe is flashed at intervals of 1/30 second each to capture images of particles passing through the flow cell, so that each particle provides a two-dimensional image having a certain area parallel to the flow cell. From the two-dimensional image area of each particle, a diameter of a circle having an identical area (an equivalent circle) is determined as a circle-equivalent diameter (CED=L₀/π). Further, for each particle, a peripheral length (L₀) of the equivalent circle is determined and divided by a peripheral length (L) measured on the two-dimensional image of the particle to determine a circularity Ci of the particle according to the above-mentioned formula (1).

Hitherto, it has been known that a toner shape affects various toner performances. As a result of our study, it has been found that if the amount of particles below 3 μm in terms of circle-equivalent diameter (C.E.D.=L₀/π), exceeds a certain level, the transferability and developing performance of the toner are liable to be lowered. Further to say, it has been found that if the amount of the particles of smaller than 3 μm (inclusive of toner particles of below 3 μm in particle size and external additive particles of below 3 μm in particle size) exceeds a certain level, it is difficult to attain desired performances unless the circularity of toner particles of 3 μm or larger is increased.

Accordingly, as a preferred feature of the present invention, it is preferred that the toner has a weight-average particle size X in a range of 5-12 μm; and contains at least 90% by number of particles satisfying a circularity Ci according to formula (1) below of at least 0.900 with respect to particles of 3 μm or larger therein,

Ci=L₀/L (1),

wherein L denotes a peripheral length of a projection image of an individual particle, and L₀ denotes a peripheral length of a circle giving an identical area as the projection image; and the toner contains a number-basis percentage Y (%) of particles having Ci≧0.950 within particles of 3 μm or larger satisfying:

Y≧X^{-0.645}×exp5.51 (2).

By satisfying the above-mentioned circularity requirement, toner particles are caused to have a lower specific surface area. As a result, the frequency of contact between the toner particles is increased to provide a higher chargeability, thus improving the dot reproducibility. Further, as the specific surface area of toner is reduced, the bulk density is lowered so that development effect is attained at a lower toner amount on the sleeve. Thus, a high developing effect is attained at a small amount of toner. This is suitable for a high-speed image forming apparatus for high printing throughput at a high speed.

In case where toner particles having a particle size (circle-equivalent diameter) of 3 μm or larger contain less than 90% by number of particles having a circularity (Ci) of at least 0.900, the contact area between the toner particles and the photosensitive member is increased to result in an increased attachment force of toner particles onto the photosensitive member, thus being liable to fail in attaining a sufficient transfer efficiency in some cases.

Further, in case where the relationship according to the above-mentioned formula (2) is not satisfied, i.e., in the case of

Y<exp5.51×X^{-0.645}

between a number-basis percentage Y (%) of particles of Ci≧0.950 within particles of 3 μm or larger and a weight-average particle size X (μm) of the toner, it becomes difficult to attain a high transfer efficiency and the toner flowability is lowered, so that developing performance and quick chargeability are liable to be impaired in a high temperature/high humidity environment in some cases.

As mentioned above, the toner may preferably have a weight-average particle size (D4=X) of 5-12 μm. It is further preferred that the toner has a weight-average particle size of 5-10 μm, contains at most 40% by number, more preferably at most 25% by number, of toner particles having particle sizes of at most 4.0 μm and at most 35% by volume, more preferably at most 20% by volume of toner particles having particle size of at least 10.1 μm.

The control of such a toner particle size is important for control of toner charge per weight of the toner for enjoying the benefit of excellent chargeability characteristic attained by the combination of the specific azo iron compound and the polyester resin having specified acid and hydroxyl values favoring the control of the presence at toner particle surface of the azo iron compound.

It is difficult for a toner having a particle size in excess of 12 μm to achieve a quick chargeability characteristic and a high chargeability. This is because the charging site per weight of toner particles is reduced to result in a lower charge per toner particle.

A weight-average particle size of toner of below 5 μm adversely affects fog in a low humidity environment and chargeability after standing in a high humidity environment.

Further, a toner containing more than 40% by number of particles of 4.0 μm or smaller is liable to cause fog and scattering due to occurrence of ultrafine powder. A toner containing more than 35% by volume of particles of 10.1 μm or larger is liable to fail in acquiring a high chargeability.

The particle size distribution referred to herein is based on values measured according to the Coulter counter method, e.g., by using “Coulter Multisizer II” (=trade name, available from Coulter Electronics Inc.).

In the measurement, a 1%-NaCl aqueous solution may be prepared by using a reagent-grade sodium chloride as an electrolytic solution. It is also possible to use ISOTON R-II (available from Coulter Scientific Japan K.K.). Into 100 to 150 ml of the electrolytic solution, 0.1 to 5 ml of a surfactant, preferably an alkylbenzenesulfonic acid salt, is added as a dispersant, and 2 to 20 mg of a sample is added thereto. The resultant dispersion of the sample in the electrolytic liquid is subjected to a dispersion treatment for about 1-3 minutes by means of an ultrasonic disperser, and then subjected to measurement of particle size distribution in the range of at least 2 μm by using the above-mentioned apparatus with a 100 μm-aperture to obtain a volume-basis distribution and a number-basis distribution. From the volume-base distribution, a weight-average particle size (D4 =X) is calculated.

The toner of the present invention may further contain a wax, examples of which may include: aliphatic hydrocarbon waxes, such as low-molecular weight polyethylene, low-molecular weight polypropylene, polyolefin copolymers, polyolefin wax, microcrystalline wax, paraffin wax, and Fischer-Tropsche wax oxides of aliphatic hydrocarbon waxes, such as oxidized polyethylene wax, and block copolymers of these; waxes principally comprising aliphatic acid esters, such as montaic acid ester wax and castor wax; vegetable waxes, such as candelilla wax, carnauba wax and wood wax; animal waxes, such as bees wax, lanolin and whale wax; mineral waxes, such as ozocerite, ceresine, and petroractum; partially or wholly de-acidified aliphatic acid esters, such as deacidified carnauba wax. Further examples may include: saturated linear aliphatic acids, such as palmitic acid, stearic acid and montaic acid and long-chain alkylcarboxylic acids having longer chain alkyl groups; unsaturated aliphatic acids, such as brassidic acid, eleostearic acid and valinaric acid; saturated alcohols, such as stearyl alcohol, eicosy alcohol, behenyl alcohol, carnaubyl alcohol, ceryl alcohol and melissyl alcohol and long-chain alkyl alcohols having longer chain alkyl groups; polybasic alcohols, such as sorbitol, aliphatic acid amides, such as linoleic acid amide, oleic acid amide, and lauric acid amide; saturated aliphatic acid bisamides, such as methylene-bisstearic acid amide, ethylene-biscopric acid amide, ethylene-bislauric acid amide, and hexamethylene-bisstearic acid amide; unsaturated aliphatic acid amides, such as ethylene-bisoleic acid amide, hexamethylene-bisoleic acid amide, N,N′-dioleyladipic acid amide, and N,N-dioleylsebacic acid amide; aromatic bisamides, such as m-xylene-bisstearic acid amide, and N,N′-distearylisophthalic acid amide; aliphatic acid metal soaps (generally called metallic soaps), such as calcium stearate, calcium stearate, zinc stearate and magnesium stearate; waxes obtained by grafting vinyl monomers such as styrene and acrylic acid onto aliphatic hydrocarbon waxes; partially esterified products between aliphatic acid and polyhydric alcohols, such as behenic acid monoglyceride; and methyl ester compounds having hydroxyl groups obtained by hydrogenating vegetable oil and fat.

It is also preferred to use a wax having a narrower molecular weight distribution or a reduced amount of impurities, such as low-molecular weight solid aliphatic acid, low-molecular weight solid alcohol, or low-molecular weight solid compound, by the press sweating method, the solvent method, recrystallization, vacuum distillation, super-critical gas extraction or fractionating crystallization.

The wax used in the present invention may preferably have a sharp molecular weight distribution as represented by a ratio (Mw/Mn) of 1.0 to 2.0 between its weight-average molecular weight (Mw) and number average molecular weight (Mn). The toner of the present invention may preferably exhibit at least one heat-absorption peak in a temperature range of 60-120° C. according to differential scanning calorimetry (DSC) as a result of containing such a wax.

The effects of the present invention can be enhanced by use of a wax having such a narrow molecular weight distribution and heat-absorption characteristic (wax melting point).

The molecular weight (distribution) and melting point of wax described herein are based on values measured in the following manner.

<Wax GPC Measurement>

| | |
|---|---|
| Apparatus: | “GPC-150C” (made by Waters Co.) |
| Column: | “GMH-HT” (made by Toso K.K.) |
| Temperature: | 135° C. |
| Solvent: | o-dichlorobenzene (0.1%-ionol added). |
| Flow rate: | 1.0 ml/min. |
| Sample volume: | 0.4 ml (conc. 0.15 wt. %) |

Based on the above measurement, the molecular weight levels are first determined based on a molecular weight calibration curve obtained by using mono-disperse polystyrene standard samples and then converted into wax molecular weights according to a conversion formula derived from the Mark-Houwink viscosity formula.

<Wax Melting Point>

Wax melting point is determined based on a peaktop temperature of a largest peak on a DSC curve obtained at a temperature-raising rate of 10° C./min according to ASTM D3418-82 by using a differential scanning calorimeter (e.g., “DSC-7”, made by Perkin-Elmer Corp.; or “DSC2920”, made by TA Instruments Japan K.K.).

A higher wax-melting point provides a good anti-high-temperature characteristic but is liable to result in an inferior low-temperature fixability. Further, because of an increased self-cohesion, the wax dispersion in the resin is liable to be impaired, thus leading to a lower developing performance.

If the wax has a lower melting point and a broad molecular weight distribution, the low-molecular weight fraction of the toner is liable to impair the flowability, quick chargeability characteristic, storage stability and transferability of the resultant toner.

The toner of the present invention may contain a magnetic iron oxide or metal as a colorant. The magnetic iron oxide may comprise magnetite, maghemite or ferrite. Examples of the metal may include: metals, such as iron, cobalt and nickel, alloys of these metals with another metal such as aluminum, cobalt, copper, lead, magnesium manganese, selenium, titanium, tungsten or vanadium; and mixtures of these. It is preferred to use a magnetic iron oxide comprising particles containing a non-iron element at their surface or inside of the particles in a proportion of 0.05-10 wt. %, more preferably 0.1-5 wt. %.

The non-iron element may preferably be selected from magnesium, aluminum, silicon, phosphorus and sulfur, and silicon is particularly effective for providing good chargeability. It is also possible to contain another non-iron element, such as lithium, beryllium, boron, germanium, titanium, zirconium, tin, lead, zinc, calcium, barium, scandium, vanadium, chromium, manganese, cobalt, copper, nickel, gallium, indium, silver, palladium, gold, platinum, tungsten, molybdenum, niobium, osmium, strontium, yttrium, technetium, luthenium, rhodium, or bismuth.

The magnetic iron oxide or metal may preferably be contained in the toner in a proportion of 20-200 wt. parts, more preferably 40-150 wt. parts, per 100 wt. parts of the resin component in the toner.

The magnetic iron oxide may have been treated with a silane coupling agent, a titanium or titanate coupling agent, aminosilane, etc., as desired.

The toner of the present invention may contain a flowability-improving agent externally added to toner particles. Examples thereof may include: fine powders of fluorine-containing resins, such as polyvinylidene fluoride and polytetrafluoroethylene; fine powders of inorganic oxides such as wet-process silica, dry-process silica, titanium oxide and alumina, and surface-treated products of these inorganic oxide fine powders treated with silane compounds, titanate coupling agent and silicone oil. Further examples may include: fine powders of inorganic materials, inclusive of oxides, such as zinc oxide and tin oxide; complex oxides, such as strontium titanate, barium titanate, calcium titanate, strontium zirconate and calcium zirconate; and carbonates, such as calcium carbonate and magnesium carbonate.

It is preferred to use a so-called dry-process silica or fumed silica, which is fine powdery silica formed by vapor-phase oxidation of a silicone halide, e.g., silicon tetrachloride. The basic reaction may be represented by the following scheme:

SiCl₄+2H₂+O₂→SiO₂+4HCl.

In the reaction step, another metal halide, such as aluminum chloride or titanium, can be used together with the silicon halide to provide complex fine powder of silica and another metal oxide, which can be also used as a type of silica as a preferred flowability-improving to be used in the toner of the present invention. The flowability-improving agent may preferably have an average primary particle size of 0.001-2 μm, more preferably 0.002-0.2 μm.

Examples of commercially available silica fine powder products formed by vapor-phase oxidation of silicon halides may include those available under the following trade names.

| | |
|---|---|
| Aerosil (Nippon Aerosil K.K.) | 130 |
| | 200 |
| | 300 |
| | 380 |
| | TT600 |
| | MOX170 |
| | MOX80 |
| | COK84 |
| Ca-O-SiL (Cabot Co.) | M-5 |
| | MS-7 |
| | MS-75 |
| | HS-5 |
| | EH-5 |
| Wacker HDK N20 (Wacker-Chemie CMBH) | V15 |
| | N20E |
| | T30 |
| | T40 |
| D-C Fine Silica (Dow Corning Co.) | |

Fransol (Fransil Co.)

It is further preferred to use such silica fine powder after a hydrophobization treatment. The treatment may preferably be performed so that the treated silica fine powder shows a hydrophobicity (metanol wettability) of 30-80.

The hydrophobization may be effected to treating the silica fine powder with an organosilicon compound reactive with or physically adsorbed by the silica fine powder.

Examples of the organosilicon compound may include: hexamethyldisilazane, trimethylsilane, trimethylchlorosilane, trimethylethoxysilane, dimethyldichlorosilane, methyltrichlorosilane, allyldimethylchlorosilane, allylphenyldichlorosilane, benzyldimethylchlorosilane, bromomethyldimethylchloro-silane, α-chloroethyltrichlorosilane, β-chloroethyltrichlorosilane, chloromethyldimethylchlorosilane, triorganosilylmercaptans such as trimethylsilylmercaptan, triorganosilyl acrylates, vinyldimethylacetoxysilane, dimethylethoxysilane, dimethyldimethoxysilane, diphenyldiethoxysilane, hexamethyldisiloxane, 1,3-divinyltetramethyldisiloxane, 1,3-diphenyltetramethyldisiloxane, and dimethylsiloxanes having 2-12 siloxane units per molecule including terminal units each having one hydroxyl group connected to Si; and further silicone oils, such as dimethylsilicone oil. These organosilicon compounds may be used singly, or in mixture, or in succession of two or more species.

The flowability-improving agent may preferably have a specific surface area as measured by the BET method using nitrogen adsorption (S_{BET}) of at least 30 m²/g, more preferably at least 50 m²/g, and may preferably be used in a proportion of 0.01-8 wt. parts, more preferably 0.1-4 wt. parts, per 100 wt. parts of the toner.

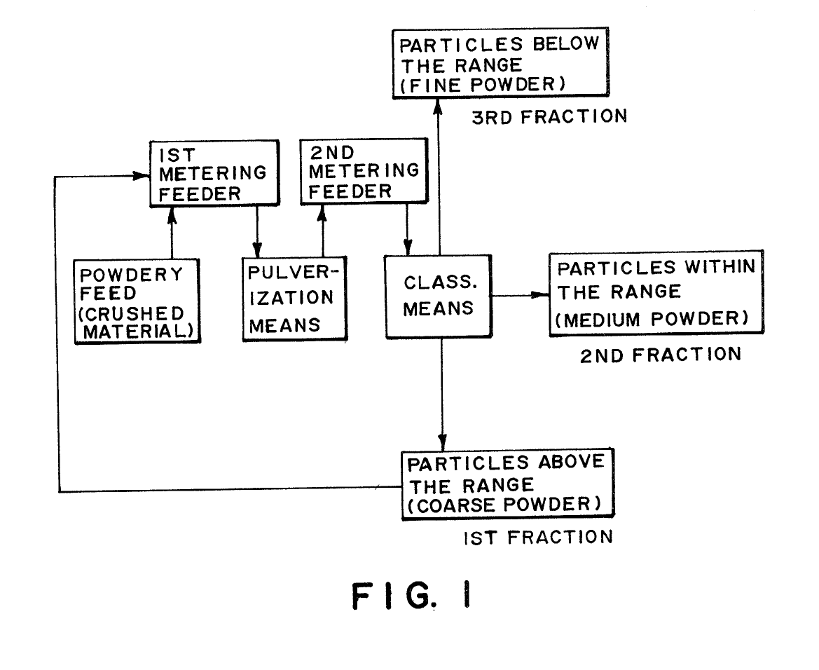

Now, a preferred embodiment of process for producing the toner of the present invention will be described. FIG. 1 is a flow chart for illustrating an outline of such an production process embodiment, wherein the toner of the present invention is produced through a process which does not include a classification step before the pulverization but includes a single path of pulverization step and classification step.

For the toner production, toner ingredients including at least a polyester binder resin, a colorant, an azo iron compound and a wax are melt-kneaded, and the melt-kneaded product after being cooled is pulverized to provide a coarsely pulverized material as a powdery feed. A prescribed amount of the pulverized material is introduced into a mechanical pulverizer including at least a rotor comprising a rotating member affixed to a central rotation shaft, and a stator housing the rotor with a prescribed spacing from the rotor surface, so that an annular space given by the spacing is made airtight, and the rotor is rotated at a high speed to finely pulverize the coarsely pulverized material. Then, the fine pulverizate is introduced to a classification step to obtain toner particles comprising a mass of particles having preferred particle sizes. In the classification step, it is preferred to use a multi-division pneumatic classifier including at least three zones for recovery of fine powder, medium powder and coarse powder. For example, in the case of using a three-division pneumatic classifier, the feed powder is classified into three types of fine powder, medium powder and coarse powder. In the classification step using such a classified, medium powder is recovered while removing the coarse powder comprising particles having sizes larger than the prescribed range and the fine powder comprising particles having sizes smaller than the prescribed range, and the medium powder is recovered as toner particles which may be used as they are as a toner product or blended with an external additive, such as hydrophobic colloidal silica to provide a toner.

The fine powder removed in the classification step and comprising particles having particle sizes below the prescribed range is generally recycled for re-utilization to the melt-kneading step for providing a coarsely pulverized melt-kneaded product comprising toner ingredients, or discarded. Ultrafine powder having further smaller particle sizes and occurring in a minor amount in the pulverization step and the classification step is also recycled for re-utilization to the melt-kneading step, or discarded.

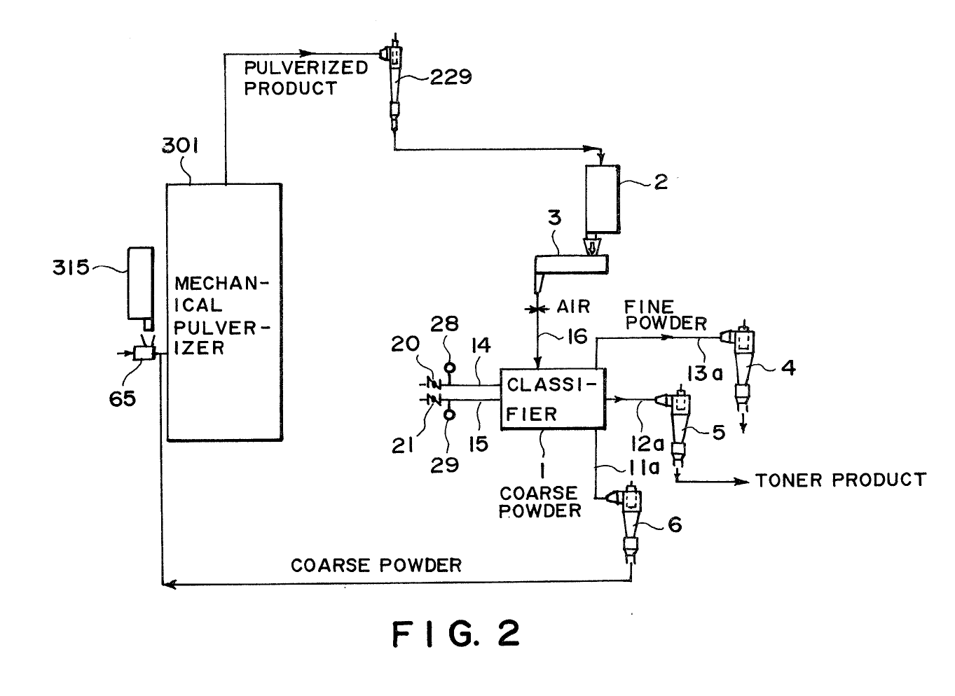

FIG. 2 illustrates an embodiment of such a toner production apparatus system. In the apparatus system, a powdery feed comprising at least a binder resin, a colorant, an azo iron compound and a wax is supplied. For example, these ingredients are melt-kneaded, cooled and pulverized to form such a powdery feed.

Referring to FIG. 2, the powdery feed is introduced at a prescribed rate to a mechanical pulverizer 301 as pulverization means via a first metering feeder 315. The introduced powdery feed is instantaneously pulverized by the mechanical pulverizer 301, introduced via a collecting cyclone 329 to a second metering feeder 2 and then supplied to a multi-division pneumatic classifier 1 via a vibration feeder 3 and a feed supply nozzle 16.

In the apparatus system, the feed rate to the multi-division pneumatic classifier, via the second metering feeder 2, may preferably be set to 0.7-1.7 times, more preferably 0.7-1.5 times, further preferably 1.0-1.2 times, the feed rate to the mechanical pulverizer 301 from the first metering feeder, in view of the toner productivity and production efficiency.

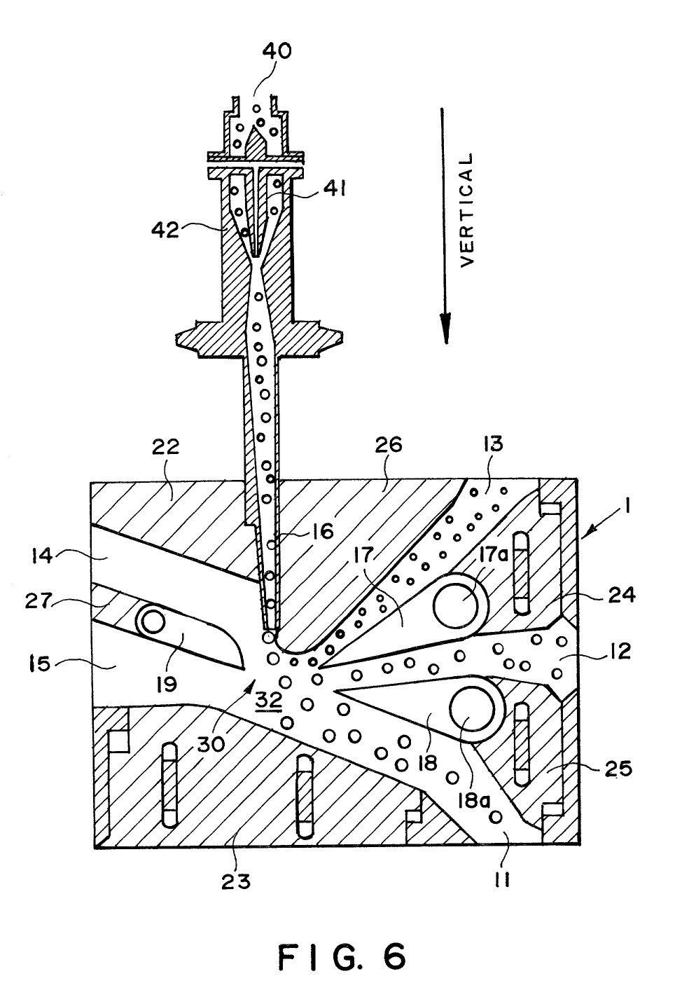

A pneumatic classifier is generally incorporated in an apparatus system while being connected with other apparatus through communication means, such as pipes. FIG. 2 illustrates a preferred embodiment of such an apparatus system. The apparatus system shown in FIG. 2 includes the multi-division classifier 1 (the details of which are illustrated in FIG. 6), the metering feeder 2, the vibration feeder 3, and collecting cyclones 4, 5 and 6, connected by communication means.

In the apparatus system, the pulverized feed is supplied to the metering feeder 2 and then introduced into the three-division classifier 1 via the vibration feeder 3 and the feed supply nozzle 16 at a flow speed of 10-350 m/sec. The three-division classifier 1 includes a classifying chamber ordinarily measuring 10-50 cm×10-50 cm×3-50 cm, so that the pulverized feed can be classified into three types of particles in a moment of 0.1-0.01 sec or shorter. By the classifier 1, the pulverized feed is classified into coarse particles, medium particles and fine particles. Thereafter, the coarse particles are sent out of an exhaust pipe 1a to a collecting cyclone 6 and then recycled to the mechanical pulverizer 301. The medium particles are sent through an exhaust pipe 12a and discharge out of the system to be recovered by a collecting cyclone 5 as a toner product. The fine particles are discharged out of the system via an exhaust pipe 13a and are discharged out of the system to be collected by a collecting cyclone 4. The collected fine particles are supplied to a melt-kneading step for providing a powdery feed comprising toner ingredients for re-utilization, or are discarded. The collecting cyclones 4, 5 and 6 can also function as a suction vacuum generation means for introducing by sucking the pulverized feed to the classifier chamber via the feed supply nozzle. The coarse particles classified out of the classifier 1 may preferably be re-introduced to the first metering feeder 315 to be mixed with a fresh powdery feed and re-pulverized in the mechanical pulverizer.

The rate of re-introduction of the coarse particles to the mechanical pulverizer 301 from the pneumatic classifier 1 may preferably be set to 0-10.0 wt. %, more preferably 0-5.0 wt. %, of the pulverized feed supplied from the second metering feeder 2 in view of the toner productivity. If the rate of re-introduction exceeds 10.0 wt. %, the powdery dust concentration in the mechanical pulverizer 301 is raised to increase the load on the pulverizer 30, and the toner productivity can be lowered due to difficulties, such as overpulverization heat causing toner surface deterioration, isolation of the magnetic iron oxide particles from the toner particles and melt-sticking onto the apparatus wall.

The powdery feed to the apparatus system may preferably have a particle size distribution such that a least 95 wt. % is 18 mesh-pass and at least 90 wt. % is 100 mesh-on (according to ASTME-11-61).

In order to produce a toner having a weight-average particle size (D4) of 5-12 μm, and a narrow particle size distribution, the pulverized product out of the mechanical pulverizer may preferably satisfy a particle size distribution including a weight-average particle size of 4-12 μm, at most 70% by number, more preferably at most 65% by number of particles of at most 4.0 μm, and at most 40% by volume, more preferably at most 35% by volume, of particles of at least 10.1 μm. Further, the medium particles classified out of the classifier 1 may preferably satisfy a particle size distribution including a weight-average particle size of 5-12 μm, at most 40% by number, more preferably at most 35% by number of particles of at most 4.0 μm, and at most 35% by volume, more preferably at most 30% by volume, of particles of at least 10.1 μm.

The apparatus system shown in FIG. 1 does not include a first classification step, prior to the pulverization step, and includes a single pass of pulverization step and classification step.

The mechanical pulverizer 301 suitably incorporated in the apparatus system of FIG. 2 may be provide by a commercially available pulverizer, such as “KTM” (available from Kawasaki Jukogyo K.K.) or “TURBOMILL” (available from Turbo Kogyo K.K.), as it is, or after appropriate re-modeling.

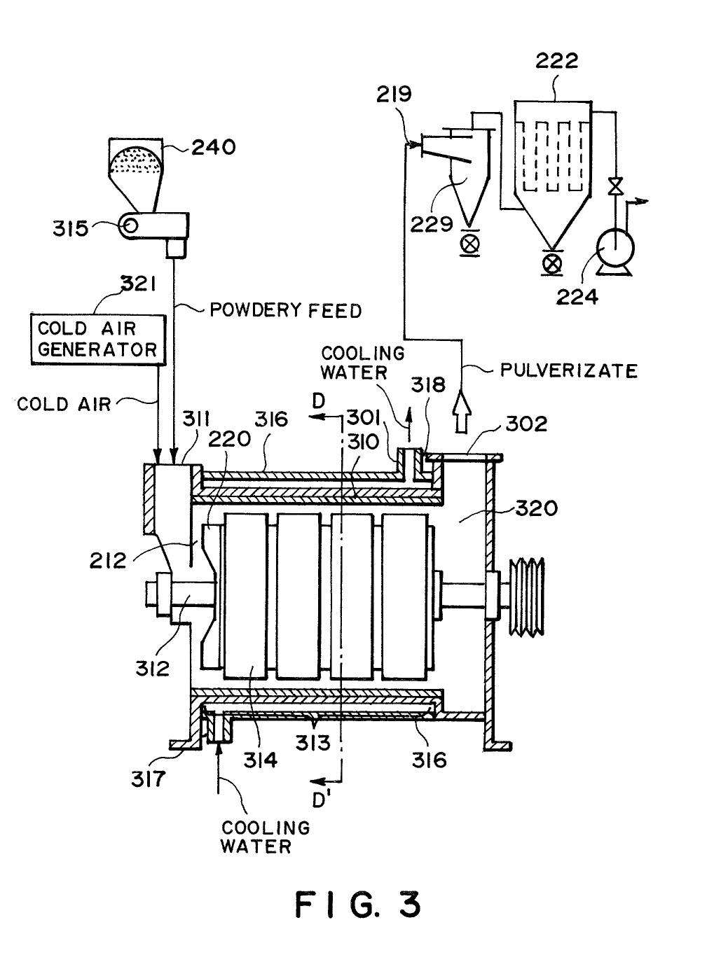

It is particularly preferred to adopt a process using a mechanical pulverizer as illustrated in FIGS. 3-5, so as to allow easy pulverization of the powdery feed and realize effective toner production.

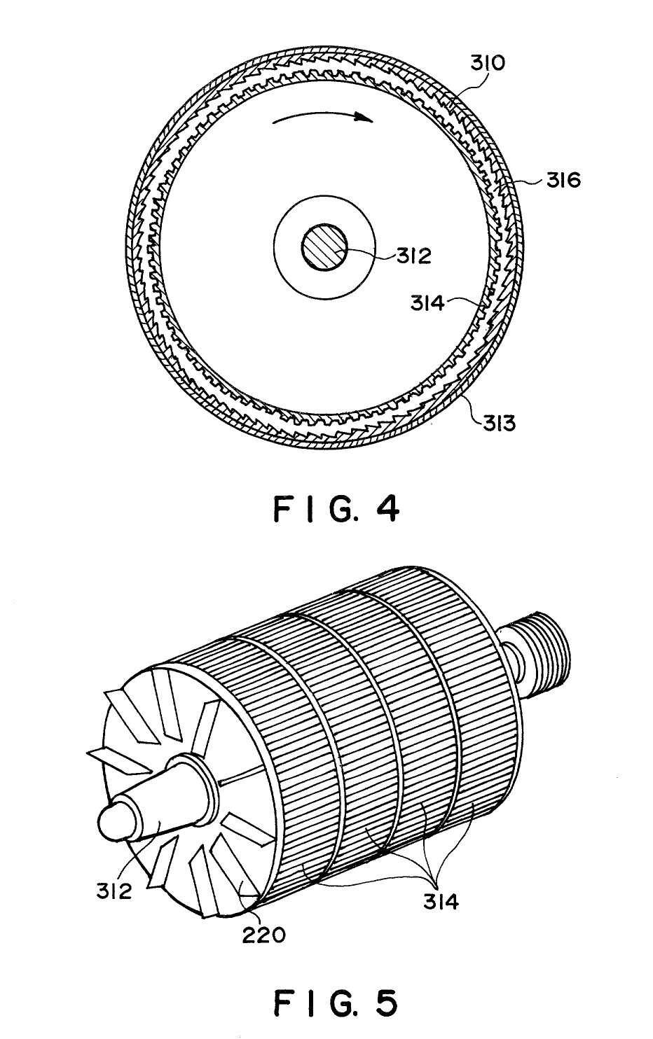

Now, the organization of a mechanical pulverizer will be described with reference to FIGS. 3-5. FIG. 3 schematically illustrates a sectional view of a mechanical pulverizer; FIG. 4 is a schematic sectional view of a D-D section in FIG. 3, and FIG. 5 is a perspective view of a rotor 314 in FIG. 3. As shown in FIG. 3, the pulverizer includes a casing 313; a jacket 316; a distributor 220; a rotor 314 comprising a rotating member affixed to a control rotation shaft 312 and disposed within the casing 313, the rotor 314 being provided with a large number of surface grooves (as shown in FIG. 5) and designed to rotate at a high speed; a stator 310 disposed with prescribed spacing from the circumference of the rotor 314 so as to surround the rotor 314 and provided with a large number of surface grooves; a feed port 311 for introducing the powdery feed; and a discharge port 302 for discharging the pulverized material.

In operation, a powdery feed is introduced at a prescribed rate from the feed port 311 into a processing chamber, where the powdery feed is pulverized in a moment under the action of an impact caused between the rotor 314 rotating at a high speed and the stator 310, respectively provided with a large number of surface grooves, a large number of ultra-high speed eddy flow occurring thereafter and a high-frequency pressure vibration caused thereby. The pulverized product is discharged out of the discharge port 302. Air conveying the powdery feed flows through the processing chamber, the discharge port 302, a pipe 219, a collecting cyclone 209, a bag filter 222 and a suction blower 224 to be discharged out of the system.

The conveying air is cold air generated by a cold air generation means 312 and introduced together with the powdery feed, and the pulverizer main body is covered with a jacket 316 for flowing cooling water (preferably, non-freezing liquid comprising ethylene glycol, etc.), so as to maintain the temperature within the processing chamber at 0° C. or below, more preferably −5 to −15° C., further preferably −7 to −12° C., in view of the toner productivity. This is effective for suppressing the surface deterioration of toner particles due to pulverization heat, particularly the liberation of magnetic iron oxide particles present at the toner particle surfaces and melt-sticking of toner particles onto the apparatus wall, thereby allowing effective pulverization of the powdery feed. The operation at a processing chamber temperature below −15° C. requires the use of flon (having a better stability at lower temperatures but regarded as less advisable from global viewpoint) instead of flon substitute as a refringerant for the cold air generation means.

The cooling water is introduced into the jacket 316 via a supply port 317 and discharged out of a discharge port 318.

In the pulverization operation, it is preferred to set the temperature T1 in a whirlpool chamber 212 (inlet temperature) and the temperature T2 in a rear chamber (outlet temperature) so as to provide a temperature difference ΔT(=T2−T1) of 30-80° C., more preferably 35-75° C., further preferably 37-72° C., thereby suppressing the surface deterioration of toner particle surfaces, and effectively pulverizing the powdery feed. A temperature difference ΔT of below 30° C. suggests a possibility of short pass of the powdery feed without effective pulverization thereof, thus being undesirable in view of the toner performances. On the other hand, ΔT>80° C. suggests a possibility of the overpulverization, resulting in surface deterioration due to heat of the toner particles and melt-sticking of toner particles onto the apparatus wall and thus adversely affecting the toner productivity.

It is preferred that the inlet temperature (T1) in the mechanical pulverizer is set to at most 0° C. and a value which is lower than the glass transition temperature (Tg) of the binder resin by 60-75° C. As a result, it is possible to suppress the surface deterioration of toner particles due to heat, and allow effective pulverization of the powdery feed. Further, the outlet temperature (T2) may preferably be set to a value which is lower by 5-30° C., more preferably 10-20° C., than Tg. As a result, it becomes possible to suppress the surface deterioration of toner particles due to heat, and allow effective pulverization of the powdery feed.

The rotor 314 may preferably be rotated so as to provide a circumferential speed of 80-180 m/s, more preferably 90-170 m/s, further preferably 100-160 m/s. As a result, it becomes possible to suppress insufficient pulverization or overpulverization, and allow effective pulverization of the powdery feed. A circumferential speed below 80 m/s of the rotor 314 is liable to cause a short pass without pulverization of the feed, thus resulting in inferior toner performances. A circumferential speed exceeding 180 m/s of the rotor invites an overload of the apparatus and is liable to cause overpulverization resulting in surface deterioration of toner particles due to heat, and also melt-sticking of the toner particles onto the apparatus wall, thus adversely affecting the toner productivity.

Further, the rotor 314 and the stator 310 may preferably be disposed to provide a minimum gap therebetween of 0.5-10.0 mm, more preferably 1.0-5.0 mm, further preferably 1.0-3.0 mm. As a result, it becomes possible to suppress insufficient pulverization or overpulverization and allow effective pulverization of the powdery feed. A gap exceeding 10.0 mm between the rotor 314 and the stator 310 is liable to cause a short pass without pulverization of the powdery feed, thus adversely affecting the toner performance. A gap smaller than 0.5 mm invites an overload of the apparatus and is liable to cause overpulverization resulting in surface deterioration of toner particles due to heat, and also melt-sticking of the toner particles onto the apparatus wall, thus adversely affecting the toner productivity.

The effective pulverization achieved by the above-mentioned mechanical pulverizer allows the omission of a pre-classification step liable to result in overpulverization and omission of the large-volume pulverization air supply required in the pneumatic pulverizer.

Next, a pneumatic classifier as a preferred classification means for toner production.

FIG. 6 is a sectional view of an embodiment of a preferred multi-division pneumatic classifier.

Referring to FIG. 6, the classifier includes a side wall 22 and a G-block 23 defining a portion of the classifying chamber, and classifying edge blocks 24 and 25 equipped with knife edge-shaped classifying edges 17 and 18. The G-block 23 is disposed slidably laterally. The classifying edges 17 and 18 are disposed swingably about shafts 17a and 18a so as to change the positions of the classifying edge tips. The classifying edge blocks 17 and 18 are slidable laterally so as to change horizontal positions relatively together with the classifying edges 17 and 18. The classifying edges 17 and 18 divide a classification zone of the classifying chamber 32 into 3 sections.

A feed port 40 for introducing a powdery feed is positioned at the nearest (most upstream) position of a feed supply nozzle 16, which is also equipped with a high-pressure air nozzle 41 and a powdery feed-introduction nozzle 42 and opens into the classifying chamber 32. The nozzle 16 is disposed on a right side of the side wall 22, and a Coanda block 26 is disposed so as to form a long elliptical arc with respect to an extension of a lower tangential line of the feed supply nozzle 16. A left block 27 with respect to the classifying chamber 32 is equipped with a gas-intake edge 19 projecting rightwards in the classifying chamber 32. Further, gas-intake pipes 14 and 15 are disposed on the left side of the classifying chamber 32 so as to open into the classifying chamber 32. Further, the gas-intake pipes 14 and 15 are equipped with first and second gas introduction control means 20 and 21, like dampers, and static pressure gauges 28 and 29 (as shown in FIG. 2).

The positions of the classifying edges 17 and 18, the G-block 23 and the gas-intake edge 18 are adjusted depending on the pulverized powdery feed to the classifier and desired particle size of the product toner.

On the right side of the classifying chamber 32, there are disposed exhaust ports 11, 12 and 13 communicative with the classifying chamber corresponding to respective classified fraction zones. The exhaust ports 11, 12 and 13 are connected with communication means such as pipes (lla, 12a and 13a as shown in FIG. 2) which can be provided with shutter means, such as valves, as desired.

The feed supply nozzle 16 may comprise an upper straight tube section and a lower tapered tube section. The inner diameter of the straight tube section and the inner diameter of the narrowest part of the tapered tube section may e set to a ratio of 20:1 to 1:1, preferably 10:1 to 2:1, so as to provide a desirable introduction speed.

The classification by using the above-organized multi-division classifier may be performed in the following manner. The pressure within the classifying chamber 32 is reduced by evacuation through at least one of the exhaust ports 11, 12 and 13. The powdery feed is introduced through the feed supply nozzle 16 at a flow speed of preferably 10-350 m/sec under the action of a flowing air caused by the reduced pressure and an ejector effect caused by compressed air ejected through the high-pressure air supply nozzle and ejected to be dispersed in the classifying chamber 32.

The particles of the powdery feed introduced into the classifying chamber 32 are caused to flow along curved lines under the action of the Coanda effect exerted by the Coanda block 26 and the action of introduced gas, such as air, so that coarse particles form an outer stream to provide a first fraction outside the classifying edge 18, medium particles form an intermediate stream to provide a second fraction between the classifying edges 18 and 17, and fine particles form an inner stream to provide a third fraction inside the classifying edge 17, whereby the classified coarse particles are discharged out of the exhaust port 11, the medium particles are discharge out of the exhaust port 12 and the fine particles are discharged out of the exhaust port 13, respectively.

In the above-mentioned powder classification, the classification (or separation) points are principally determined by the tip positions of the classifying edges 17 and 18 corresponding to the lowermost part of the Coanda block 26, while being affected by the suction flow rates of the classified air stream and the powder ejection speed through the feed supply nozzle 16.

According to the above-mentioned toner production system, it is possible to effectively produce a toner having a weight-average particle size of 5-12 μm, and a narrow particle size distribution by controlling the pulverization and classification conditions.

For the production of the toner according to the present invention, the polyester binder resin, a colorant and the azo iron compound are used as starting ingredient, but in addition thereto, it is possible to add other ingredients, such as magnetic powder, a wax and other additives, as desired. Such starting ingredients may be sufficiently blended in a blender, such as a Henschel mixer or a ball mill, and melt-kneaded for dispersion of the colorant, etc., in the resin by a hot-kneading machine such as a roll mill, a kneader or an extruder, followed by cooling, pulverization and classification to obtain a toner. Thus, the toner of the present invention can be produced not only through a preferred process using the apparatus system described with reference to FIGS. 1 to 6, but also by using apparatus and devices appropriately selected from those mentioned below so as to provide a toner having desired circularity and particle size distribution.

Thus, various machines are commercially available for production of the toner according to the present invention. Several examples thereof are enumerated below together with the makers thereof. For example, the commercially available blenders may include: Henschel mixer (mfd. by Mitsui Kozan K.K.), Super Mixer (Kawata K.K.), Conical Ribbon Mixer (Ohkawara Seisakusho K.K.); Nautamixer, Turbulizer and Cyclomix (Hosokawa Micron K.K.); Spiral Pin Mixer (Taiheiyo Kiko K.K.), Lodige Mixer (Matsubo Co. Ltd.). The kneaders may include: Buss Cokneader (Buss Co.), TEM Extruder (Toshiba Kikai K.K.), TEX Twin-Screw Kneader (Nippon Seiko K.K.), PCM Kneader (Ikegai Tekko K.K.); Three Roll Mills, Mixing Roll Mill and Kneader (Inoue Seisakusho K.K.), Kneadex (Mitsui Kozan K.K.); MS-Pressure Kneader and Kneadersuder (Moriyama Seisakusho K.K.), and Bambury Mixer (Kobe Seisakusho K.K.). As the pulverizers, Cowter Jet Mill, Micron Jet and Inomizer (Hosokawa Micron K.K.); IDS Mill and PJM Jet Pulverizer (Nippon Pneumatic Kogyo K.K.); Cross Jet Mill (Kurimoto Tekko K.K.), Ulmax (Nisso Engineering K.K.), SK Jet O. Mill (Seishin Kigyo K.K.), Krypron (Kawasaki Jukogyo K.K.), and Turbo Mill (Turbo Kogyo K.K.). As the classifiers, Classiell, Micron Classifier, and Spedic Classifier (Seishin Kigyo K.K.), Turbo Classifier (Nisshin Engineering K.K.); Micron Separator and Turboplex (ATP); Micron Separator and Turboplex (ATP); TSP Separator (Hosokawa Micron K.K.); Elbow Jet (Nittetsu Kogyo K.K.), Dispersion Separator (Nippon Pneumatic Kogyo K.K.), YM Microcut (Yasukwa Shoji K.K.). As the sieving apparatus, Ultrasonic (Koei Sangyo K.K.), Rezona Sieve and Gyrosifter (Tokuju Kosaku K.K.), Ultrasonic System (Dolton K.K.), Sonicreen (Shinto Kogyo K.K.), Turboscreener (Turbo Kogyo K.K.), Microshifter (Makino Sangyo K.K.), and circular vibrating sieves.

As described above, according to the present invention, it is possible to provide a toner capable of quickly acquiring a high charge and retaining the charge for a long period regardless of environmental conditions, thus being suitable for use in a high-speed image forming machine capable of image formation on 40 sheets or more per min., by using a specific azo iron compound and a polyester binder resin having specified acid and hydroxyl values.

Further, by forming the toner at a high circularity, the chargeability thereof is not substantially lowered even in a high temperature/high humidity environment, thus alleviating a lower image density at the time of start-up of image formation or after standing of the toner in such an environment.

Further, by producing a toner having a high circularity, the contact area between toner particles is minimized to suppress the agglomeratability of toner particles, and the toner is provided with a higher chargeability because of increased charging sites than angular toner particles. However, a toner having a high chargeability is liable to have a continually increased charge, so that a freshly replenished toner supplied onto a part on the developing sleeve at which the toner has been used in a previous development cycle is liable to have a charge difference compared with the toner surrounding the part on the developing sleeve, thereby causing a ghost where a part of image is irregularity provided with a lower image density, or on the other hand, a higher image density. However, according to a toner of the present invention comprising a combination of a polyester binder resin having specified acid and hydroxyl values and a specific azo iron compound, a high charge can be acquired quickly and can be retained for a long period, without change. Further, because of an improved flowability, the supply onto the developing sleeve and uniform chargeability of the toner are promoted. As a synergy of these factors, it becomes possible to remarkably obviate the ghost phenomenon. Moreover, the transferability is substantially increased.

Hereinbelow, the present invention will be described more specifically based on Examples, which however should not construed to restrict the scope of the present invention in any way. “Part(s)” means “parts by weight” unless noted otherwise specifically.

<Azo Iron Compounds>

### PRODUCTION EXAMPLE 1

A monoazo compound obtained through ordinary disazo coupling between 4-chloro-2-aminophenol and 6-t-octyl-2-naphthol was added to and stirred together with N,N-dimethylformamide. To the resultant solution, sodium carbonate was added and heated together at 70° C., and ferric (III) sulfate hepta-hydrate was added thereto to effect 5 hours of reaction.

The reaction liquid was then dispersed in water, and the precipitate was filtered out and washed with water to obtain a wet cake having a moisture content of 20 wt. %, which was then dried in a paddle drier to obtain Azo iron compound (I) represented by Formula (I) below.

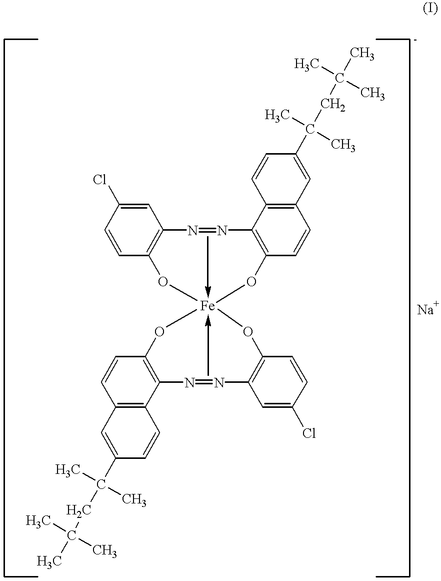

### PRODUCTION EXAMPLE 2

Azo iron compound (II) represented by Formula (II) shown below was prepared in the same manner as in Production Example 1 except for using 4-t-butyl-2-aminophenol instead of the 4-chloro-2-aminophenol.

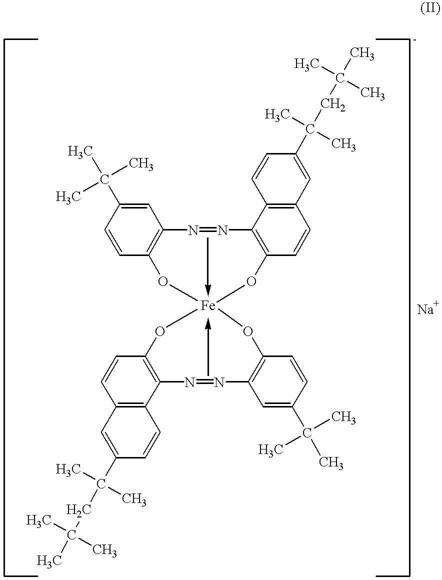

### PRODUCTION EXAMPLE 3

Azo iron compound (III) represented by Formula (III) shown below was prepared in the same manner as in Production Example 1 except for using 2-aminophenol instead of the 4-chloro-2-aminophenol.

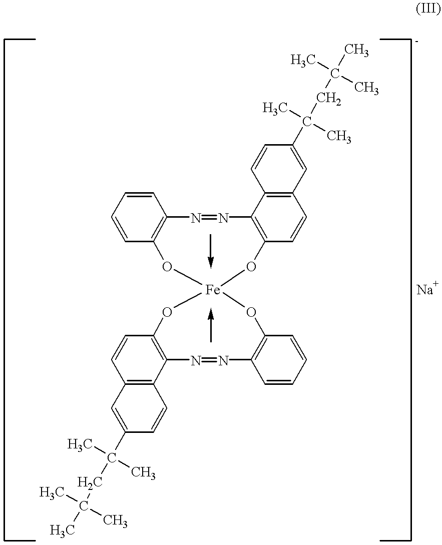

### PRODUCTION EXAMPLE 4

Azo iron compound (IV) represented by Formula (IV) shown below was prepared in the same manner as in Production Example 1 except for using 6-t-butyl-2-naphthol instead of the 6-t-octyl-2-naphthol.

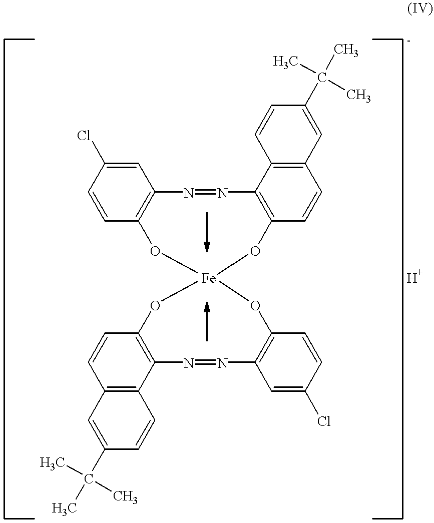

### PRODUCTION EXAMPLE 5

Azo iron compound (V) represented by Formula (V) shown below was prepared in the same manner as in Production Example 1 except for using 6-n-butyl-2-5 naphthol instead of the 6-t-octyl-2-naphthol.

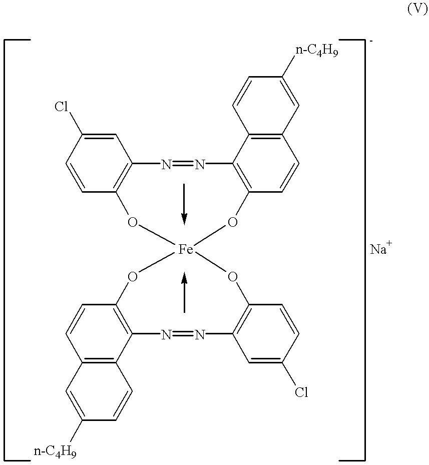

### PRODUCTION EXAMPLE 6

Azo iron compound (VI) represented by Formula (VI) shown below was prepared in the same manner as in Production Example 1 except for using 3-methyl-2-naphthol instead of the 6-t-octyl-2-naphthol.

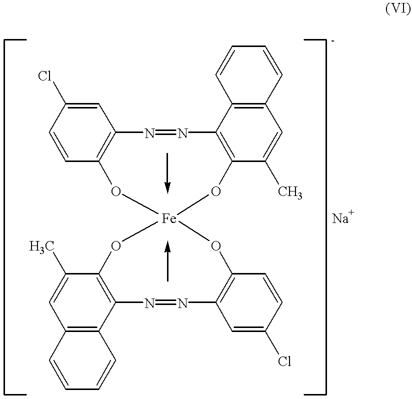

### PRODUCTION EXAMPLE 7

Azo iron compound (VII) represented by Formula (VII) shown below was prepared in the same manner as in Production Example 1 except for using 6-n-octyl-2-naphthol instead of the 6-t-octyl-2-naphthol.

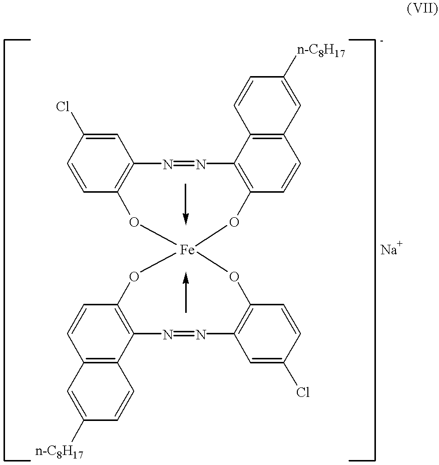

### PRODUCTION EXAMPLE 8

Azo chromium compound (VIII) represented by Formula (VIII) shown below was prepared in the same manner as in Production Example 1 except for using 4-t-pentyl-2-aminophenol and 2-naphthol instead of the 4-chloro-2-aminophenol and the 6-t-octyl-2-naphthol, respectively, and changing the central metal to Cr (chromium).

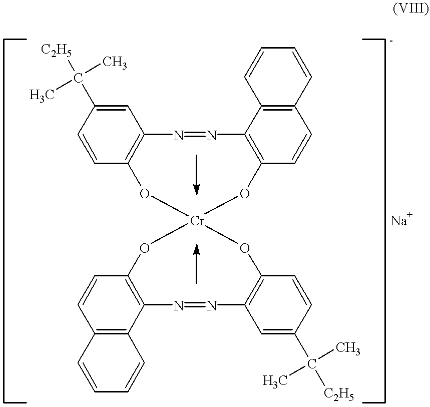

### PRODUCTION EXAMPLE 9

Azo iron compound (IX) represented by Formula (IX) shown below was prepared in the same manner as in Production Example 1 except for using 2-naphtyl instead of the 6-b-octyl-2-naphthol.

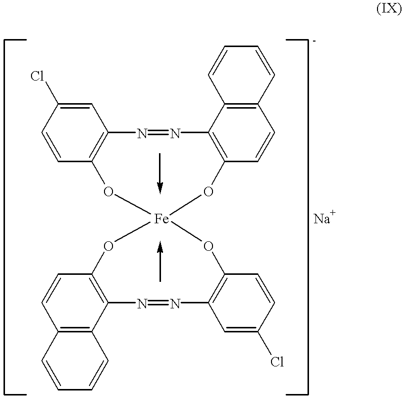

<Polyester Resins>

| (Production Example 1) | |
|---|---|
| Terephthalic acid | 81 mol |
| Trimellitic acid | 20 mol |
| Propylene oxide-added | 85 mol |
| bisphenol A (PO-BPA) | |
| Ethyleneoxide-added | 35 mol |
| bisphenol A (EO-BPA) | |

The above monomers (carboxylic acids and alcohols) were subjected to polycondensation in the presence of a tin-based esterification catalyst to obtain Polyester resin (P-1), which showed Tg=62° C., Av (acid value)=5 mgKOH/g and OHv (hydroxyl value)=27.8 mgKOH/g.

### PRODUCTION EXAMPLES 2 TO 10

Polyester resins (P-2) to (P-10) were prepared in the same manner as in Production Example 1 except for changing the monomer compositions respectively as shown in Table 1 below. Av and OHv values of Polyester resins P-1 to P-10 are inclusively shown in Table 3 appearing hereinafter.

TABLE 1
Polyester resin (monomer composition)

| Polyester | monomers* (mol) | | | | | | |
|---|---|---|---|---|---|---|---|
| resin | PO-BPA | EO-BPA | FA | TPA | TMA | APA | SA |
| P-1 | 85 | 35 | — | 81 | 20 | — | — |
| P-2 | 68 | 34 | — | 43 | 12 | — | 40 |
| P-3 | 70 | 33 | — | 28 | 30 | 38 | — |
| P-4 | 70 | 26 | 32 | — | 5 | — | — |
| P-5 | 59 | 55 | — | 90 | 40 | — | — |
| P-6 | 52 | 34 | 78 | — | 34 | — | — |
| P-7 | — | 90 | — | 70 | 27 | — | 27 |
| P-8 | 90 | — | — | 70 | 20 | — | — |
| P-9 | — | 85 | — | 90 | 27 | — | 30 |

*PO-BPA = propylene oxide-added bisphenol A
EO-BPA = ethylene oxide-added bisphenol A
FA = fumaric acid
TPA = terephthalic acid
TMA = trimellitic acid
APA = adipic acid
SA = dodecenylsuccinic acid

### EXAMPLE 1

| | |
|---|---|
| Polyester resin P-1 | 100 wt.parts |
| Magnetic iron oxide** | 90 wt.parts |
| Fischer-tropsche wax | 4 wt.parts |
| (Tmp = 95° C., Mw/Mn = 1.3) | |
| Azo-iron compound (I) | 2 wt.parts |

**Spherical magnetic iron oxide (containing 1.2 wt. % of Si, 0.2 wt. % of Al, D1 = 0.20 μm)

The above ingredients were melt-kneaded by a twin-screw extruder heated at 130° C. After being cooled, the kneaded product was coarsely crushed by a hammer mill and then pulverized by an impingement-type jet air stream pulverizer (“Jet Mill”, made by Nippon Pneumatic Kogyo K.K.). The resultant pulverizate was pneumatically classified by a multi-division classifier utilizing Coanda effect having a structure as illustrated in FIG. 6 (“Elbow Jet”, made by Nittetsu Kogyo K.K.), thereby strictly removing a fine powder fraction and a coarse powder fraction to recover a medium powder fraction as Classified powder 1.

Then, 100 wt. parts of Classified powder 1 was blended with 1.2 wt. parts of Hydrophobized silica (hydrophobized with dimethylsilicone oil and hexamethyldisilazane, and showing S_{BET}=150 m²/g, and a methanol wettability of 69%) by a Henschel mixer to obtain Toner 1. The toner compositions are summarized in Table 2 together with those of toners prepared in Examples and Comparative Examples prepared hereinafter.

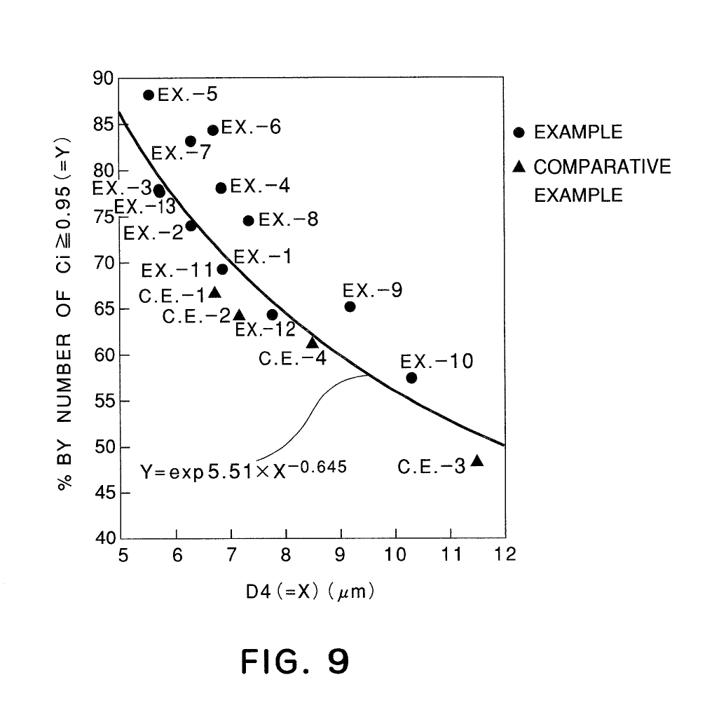

Toner 1 exhibited a weight-average particle size (D4)=6.8 mm, contained 89.7% by member (N %) of particles of circularity (Ci)≧0.900 and 70.5 N % of particles of Ci≧0.950. The measured results are summarized in Table 3 and a spot of correlation between D4 (=X) and % of particles of Ci≧0.950 is shown in FIG. 9 together with those of toners prepared in Examples and Comparative Examples.

(1) Image Density (I.D.)

Toner 1 was filled in a process cartridge and then charged in a commercially available laser beam printer (“LBP950”, made by Canon K.K.) after remodeling so as to allow a printing speed increased from 32 sheets (A4-vertical)/min. to 50 sheets (A4-vertical)/min. (i.e., a process speed of 310 mm/sec), and tested for evaluation of toner performances with respect to the following items.

Each toner sample was first subjected to an intermittent image forming test (thinned-out continual image forming test) at a rate of 2 sheets/20 sec. on 3000 sheets (for a total period of about 8.3 hours). The intermittent image forming test was repeated on three days in a high temperature/high humidity environment (32.5° C./80% RH). Thereafter, the printer and the toner was left standing for 2 days in the same environment. Then, the intermittent image forming test were again performed at a rate of 2 sheets/20 sec., whereby the image density was measured immediately after re-starting and on a 500-th sheet (on a 9500-th sheet from the start of the test).

The image density was measured by using a Macbeth reflection densitometer (made by Macbeth Co.).

(2) Positive Ghost

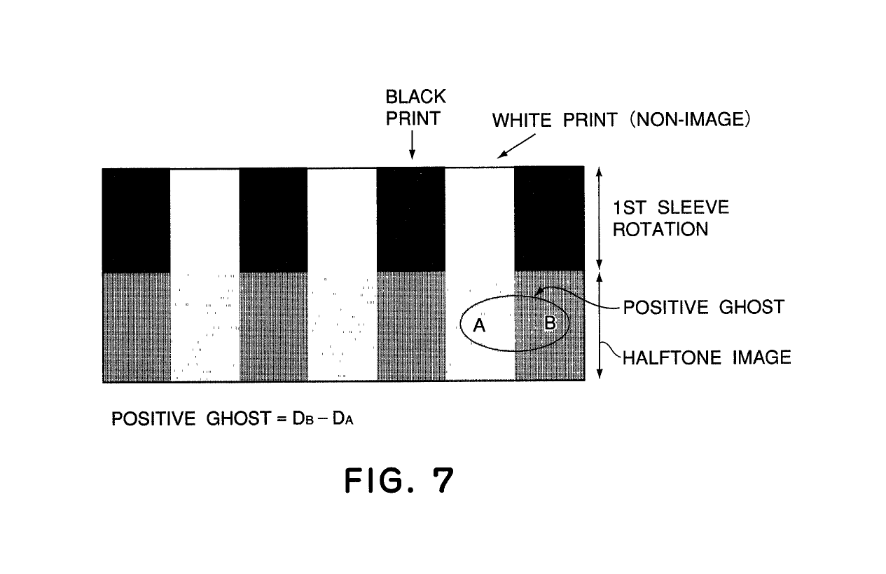

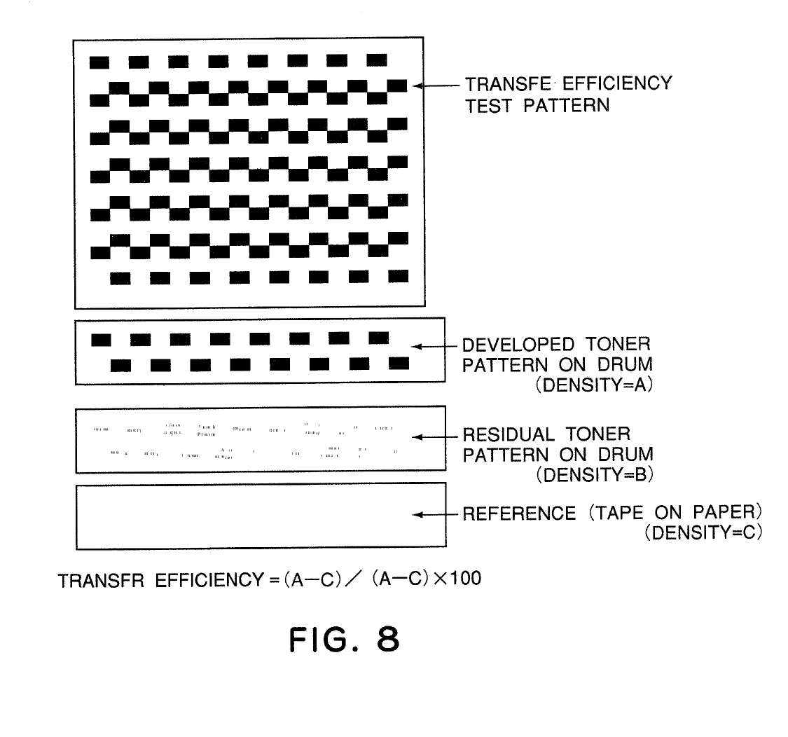

In the high temperature/high humidity environment (32.5° C./80% RH), printing was continuously performed on 30,000 sheets of plain paper (75 g/m²) in order to evaluate positive ghost (as illustrated in FIG. 7), at the time of completion of the continuous priting test. By first sleeve rotation, a black-and-white stripe pattern was printed, and a halftone image was printed thereafter. Then, at the second sleeve rotation part, a density (D_{B}) of halftone image at a portion following the black stripe in the previous rotation and a density (D_{A}) of halftone image following the white stripe pattern were measured. Then, a positive ghost level (Gp) was calculated as Gp=D_{B}−D_{A}, and based on the measured ghost level, the evaluation was performed according to the following standard:

A: 0.0-below 0.2

B: 0.2-below 0.5

C: 0.5-below 0.7

D: 0.7-below 1.0

E: ≧1.10

(3) Transfer Efficiency (Teff)

Continuous printing was performed on 30,000 sheets at a rate of 6,000 sheets/day while taking internal between days. After printing on 6,000 sheets on the first day, a transfer efficiency was tested by printing a test pattern as shown in FIG. 8, and the machine was stopped before completion of the transfer of the toner image onto paper. Toner patterns before and after the transfer were respectively peeled off by an adhesive tape and applied onto white paper to measure the reflection densities A and B, respectively. Separately, a blank adhesive tape was applied to measure a reference density C. A transfer efficiency Teff (%) was calculated by Teff (%)={(A−B)/(A−C)}×100. The outline of the transfer efficiency measurement is illustrated in FIG. 8.

(4) Fog

A continuous printing was performed on 6000 sheets in a low temperature/low humidity environment (15° C./10% RH), and a solid white image was printed at every 500th sheet to measure a whiteness of the printed solid image by means of a reflectometer (made by Tokyo Denshoku) relative to a preliminarily measured whiteness of the blank white paper. The maximum difference in whiteness among the measured values of every 500th solid white printed image was recorded.

(5) Severe Standing Test (I.D. after 45° C./90%, 7 Days)

A toner sample was left standing for 7 days in an environment of 45° C. and 90% RH and then left to stand for 1 day in a normal temperature/normal humidity environment (23° C./60% RH). Thereafter, in the same environment, a solid image density was measured at an initial stage and on a 500th-sheet by a Macbeth densitometer.

(6) Halftone Image Quality

A continuous printing was performed on 1000 sheets in an environment of 23° C./65% RH. A large-area halftone image on every 500th sheet was evaluated with respect to image density irregularity (uniformity) and gradation reproducibility. The evaluation result was recorded according to the following standard.

A: No irregularity, excellent gradation.

B: Slight irregularity rarely, excellent gradation.

C: Irregularity sometimes, slightly inferior gradation (practical level).

D: Irregularity occurred over a wide area, somewhat inferior gradation.

E: Irregularity occurred over a wide area, inferior irregularity.

The results of the above test and evaluation for Toner 1 are inclusively shown in Table 4 together with those of toners obtained in Examples and Comparative Examples described below.

### EXAMPLES 2 AND 3

Toners 2 and 3 were prepared and evaluated in the same manner as in Example 1 except for changing the toner compositions as shown in Table 2.

### EXAMPLE 4

| | |
|---|---|
| Polyester resin P-1 | 100 wt.parts |
| Magnetic iron oxide | 95 wt.parts |
| (the same as in Example 1) | |
| Fischer-tropsche wax | 4 wt.parts |
| (Tmp = 95° C., Mw/Mn = 1.3) | |
| Azo-iron compound (I) | 2 wt.parts |

The above-ingredients were melt-kneaded, and coarsely crushed by a hammer mill, in the same manner as in Example 1. The crushed product was then pulverized by a mechanical pulverizer having a structure as illustrated in FIGS. 3 to 5 (“Turbo Mill”, made by Turbo Kogyo K.K.), and thereafter classified by a multi-division classifier in the same manner as in Example 1 to obtain Classified powder 4.

100 wt. parts of Classified powder 4 was blended with 1.2 wt. % of Hydrophobized silica (the same as in Example 1) in the same manner as in Example 1 to obtain Toner 4, which was thereafter evaluated in the same manner as in Example 1.

### EXAMPLE 5

Toner 5 was prepared and evaluated in the same manner as in Example 4 except for changing the toner composition as shown in Table 2.

### EXAMPLE 6

A toner composition shown in Table 2 was melt-kneaded, coarsely crushed and pulverized by a jet-air stream pulverizer in the same manner as in Example 1. The pulverized product was subjected to a sphering-treatment by a hybridizer (made by Nara Kikai Seisakusho). Thereafter, the treated powder was classified and blended with Hydrophobized silica in the same manner as in Example 1 to prepare Toner 6, which was thereafter evaluated in the same manner as in Example 1.

### EXAMPLES 7-10

Toners 7-10 were prepared and evaluated in the same manner as in Example 4 except for changing the toner compositions as shown in Table 2.

The magnetic material used in Example 10 (and also in the following Examples and Comparative Examples) was a magnetic iron oxide containing no non-iron element such as Si or Al and having a number-average particle size (D1) of 0.20 μm.

### EXAMPLES 11 TO 13

Toners 11 to 13 were prepared and evaluated in the same manner as in Example 1 except for changing the toner compositions as shown in Table 2.

### COMPARATIVE EXAMPLES 1 TO 4

Comparative Toners 1 to 4 were prepared and evaluated in the same manner as in Example 1 except for changing the toner compositions as shown in Table 2.

Regarding the toners prepared in the above Examples and Comparative Examples, the toner compositions are inclusively shown in Table 2; the toner characteristics, in Table 3; and the toner performances, in Table 4.

TABLE 2
Toner composition

| | | | Azo-iron | | External | | Magnetic | | | | | |
|---|---|---|---|---|---|---|---|---|---|---|---|---|
| | | | compound | | additive | | iron oxide | | Wax | | | |
| Example | Toner | Polyester resin | name | parts | species | parts | type | parts | type | Mw/Mn | Tmp. (°C.) | parts |
| 1 | 1 | P-1 | I | 2 | silica | 1.2 | with Si | 90 | Fischer- | 1.3 | 95 | 4 |
| | | | | | | | | | Tropsche | | | |
| 2 | 2 | P-2 | II | 2 | ↑ | 1.3 | ↑ | 95 | ↑ | ↑ | ↑ | 4 |
| 3 | 3 | P-3 | III | 2 | ↑ | 1.5 | ↑ | 100 | polyethylene | 1.2 | 106 | 4 |
| 4 | 4 | P-1 | I | 2 | ↑ | 1.2 | ↑ | 95 | Fischer- | 1.3 | 95 | 4 |
| | | | | | | | | | Tropsche | | | |
| 5 | 5 | P-2 | II | 2 | ↑ | 1.2 | ↑ | 95 | ↑ | ↑ | ↑ | 4 |
| 6 | 6 | P-3 | III | 2 | ↑ | 1.2 | ↑ | 90 | paraffin | 1.4 | 82 | 4 |
| 7 | 7 | P-4 | I | 2.2 | ↑ | 1.4 | ↑ | 100 | polyethylene | 1.2 | 106 | 4 |
| 8 | 8 | P-5 | IV | 2 | ↑ | 1.0 | ↑ | 90 | ↑ | ↑ | ↑ | 4 |
| 9 | 9 | P-5 | VII | 2 | ↑ | 0.9 | ↑ | 85 | ↑ | ↑ | ↑ | 4 |
| 10 | 10 | P-6 | V | 1.5 | ↑ | 0.8 | no Si | 80 | polypropylene | 3.2 | 142 | 4 |
| 11 | 11 | P-6 | III | 2 | ↑ | 1.2 | ↑ | 95 | paraffin | 1.4 | 82 | 4 |
| 12 | 12 | P-7 | VI | 2 | ↑ | 0.8 | ↑ | 80 | ↑ | ↑ | ↑ | 4 |
| 13 | 13 | P-7 | IV | 2 | ↑ | 1.3 | ↑ | 100 | polypropylene | 3.2 | 142 | 4 |
| Comp. 1 | 14 | P-7 | VI | 2 | ↑ | 1.2 | ↑ | 95 | Fischer- | 1.3 | 95 | 4 |
| | | | | | | | | | Tropsche | | | |
| Comp. 2 | 15 | P-8 | VIII | 2 | ↑ | 1.2 | ↑ | 95 | paraffin | 1.4 | 82 | 4 |
| Comp. 3 | 16 | P-6 | I↑ | 1.5 | ↑ | 0.7 | ↑ | 80 | polypropylene | 3.2 | 142 | 4 |
| Comp. 4 | 17 | P-9 | VI | 2 | ↑ | 1.2 | ↑ | 95 | ↑ | ↑ | ↑ | 4 |

↑ means the same as above.

TABLE 3
Toner characteristics

| | | | Toner resin | | | | |
|---|---|---|---|---|---|---|---|
| | | | Av | OHv | | | Tg |
| Example | Toner | Polyester resin | (mgKOH/g) | (mgKOH/g) | Av/OHv | Av + OHv | (°C.) |
| 1 | 1 | P-1 | 5 | 27.8 | 0.18 | 29.8 | 62 |
| 2 | 2 | P-2 | 15 | 18 | 0.83 | 33.00 | 61 |
| 3 | 3 | P-3 | 18.4 | 20.2 | 0.91 | 38.60 | 55 |
| 4 | 4 | P-1 | 5 | 27.8 | 0.18 | 29.8 | 62 |
| 5 | 5 | P-2 | 15 | 18 | 0.83 | 33.00 | 61 |
| 6 | 6 | P-3 | 18.4 | 20.2 | 0.91 | 38.60 | 55 |
| 7 | 7 | P-4 | 2.5 | 33 | 0.08 | 35.5 | 59 |
| 8 | 8 | P-5 | 12 | 44 | 0.27 | 56.00 | 56.8 |
| 9 | 9 | P-5 | 12 | 44 | 0.27 | 56.00 | 55.4 |
| 10 | 10 | P-6 | 28 | 44 | 0.64 | 72.00 | 58 |
| 11 | 11 | P-6 | 28 | 44 | 0.64 | 72.00 | 55.4 |
| 12 | 12 | P-7 | 29 | 20 | 1.45 | 49.00 | 59.2 |
| 13 | 13 | P-7 | 29 | 20 | 1.45 | 49.00 | 60 |
| Comp. 1 | 14 | P-7 | 29 | 20 | 1.45 | 49.00 | 58 |
| Comp. 2 | 15 | P-8 | 41 | 14.5 | 2.83 | 55.50 | 55 |
| Comp. 3 | 16 | P-6 | 28 | 44 | 0.64 | 72.00 | 55.4 |
| Comp. 4 | 17 | P-9 | 1.4 | 51 | 0.03 | 52.40 | 56 |

Particle size distribution

| | Azo iron | D₄ = X | ≦4 μm | ≧10 μm | N% for D ≧ 3 μm | | exp5.51 × |
|---|---|---|---|---|---|---|---|
| Example | cmpd. | (μm) | (N%) | (V%) | Ci ≧ 0.900 | Ci ≧ 0.950 | X^{0.645} |
| 1 | I | 6.80 | 20.1 | 1.2 | 89.7 | 70.5 | 71.78 |
| 2 | II | 6.35 | 22.3 | 0.9 | 91.2 | 74.1 | 75.02 |
| 3 | III | 5.78 | 29.5 | 0.3 | 93.4 | 78.2 | 79.71 |
| 4 | I | 6.90 | 19.5 | 1.5 | 95.9 | 78.1 | 71.11 |
| 5 | II | 5.60 | 39.5 | 1.1 | 96.7 | 88.3 | 81.35 |
| 6 | III | 6.75 | 20.2 | 2.1 | 95.6 | 84.3 | 72.12 |
| 7 | I | 6.35 | 25.6 | 2.2 | 96.1 | 83.2 | 75.02 |
| 8 | IV | 7.40 | 17.6 | 1.0 | 94.8 | 74.6 | 67.97 |
| 9 | VII | 9.20 | 13.3 | 16.8 | 92.4 | 65.1 | 59.06 |
| 10 | V | 10.30 | 5.2 | 38.2 | 90.3 | 57.3 | 54.91 |
| 11 | III | 6.90 | 19.5 | 1.5 | 89.5 | 69.2 | 71.11 |
| 12 | VI | 7.80 | 21.2 | 2.1 | 89.1 | 64.3 | 65.70 |
| 13 | IV | 5.80 | 40.1 | 0.9 | 92 | 77.5 | 79.53 |
| Comp. 1 | VI | 6.75 | 20.6 | 2.3 | 90 | 66.8 | 72.12 |
| Comp. 2 | VIII | 7.20 | 16.2 | 4.3 | 88.6 | 64.2 | 69.18 |
| Comp. 3 | IX | 11.50 | 4.6 | 40.0 | 73.6 | 50.9 | 51.15 |
| Comp. 4 | VI | 8.51 | 15.3 | 3.5 | 90 | 61.1 | 62.11 |

TABLE 4
Toner performances

| | | | | | I.D. after | | | | | |
|---|---|---|---|---|---|---|---|---|---|---|
| | | Image density in HT/HH | | | 45° C./90%. 7 days | | | | | |
| | | After | After | | | | Fog | Positive | | |
| Example | Toner | 9000 sheets | 2 days stand | 9500th sheet | initial | 500th | LT/LH | ghost | Teff (%) | Halftone |
| 1 | 1 | 1.49 | 1.45 | 1.47 | 1.48 | 1.47 | 1.1 | B | 91.2 | B |
| 2 | 2 | 1.46 | 1.45 | 1.47 | 1.46 | 1.46 | 1.5 | B | 89.5 | B |
| 3 | 3 | 1.46 | 1.45 | 1.44 | 1.45 | 1.45 | 2.1 | C | 91.0 | B |
| 4 | 4 | 1.51 | 1.49 | 1.51 | 1.50 | 1.51 | 0.9 | A | 95.0 | A |
| 5 | 5 | 1.49 | 1.46 | 1.48 | 1.47 | 1.49 | 1.4 | A | 92.8 | A |
| 6 | 6 | 1.46 | 1.46 | 1.47 | 1.46 | 1.48 | 1.2 | B | 93.8 | A |
| 7 | 7 | 1.49 | 1.47 | 1.50 | 1.48 | 1.49 | 1.0 | A | 95.1 | A |
| 8 | 8 | 1.44 | 1.43 | 1.43 | 1.42 | 1.44 | 1.8 | B | 91.5 | B |
| 9 | 9 | 1.43 | 1.40 | 1.41 | 1.41 | 1.42 | 1.7 | B | 91.1 | C |
| 10 | 10 | 1.42 | 1.39 | 1.39 | 1.38 | 1.41 | 1.9 | B | 88.1 | C |
| 11 | 11 | 1.44 | 1.40 | 1.39 | 1.39 | 1.43 | 2.1 | C | 86.5 | C |
| 12 | 12 | 1.40 | 1.38 | 1.38 | 1.38 | 1.38 | 1.5 | C | 84.5 | C |
| 13 | 13 | 1.42 | 1.41 | 1.41 | 1.42 | 1.42 | 1.9 | C | 87.1 | C |
| Comp. 1 | 14 | 1.25 | 1.18 | 1.23 | 1.30 | 1.32 | 2.2 | C | 79.2 | D |
| Comp. 2 | 15 | 1.38 | 1.20 | 1.25 | 1.35 | 1.36 | 2.0 | C | 79.1 | E |
| Comp. 3 | 16 | 1.25 | 1.15 | 1.21 | 1.35 | 1.37 | 2.1 | D | 78.2 | E |
| Comp. 4 | 17 | 1.38 | 1.28 | 1.35 | 1.35 | 1.37 | 3.0 | C | 81.1 | D |

As described above, according to the present invention, it is possible to obtain a toner capable of exhibiting a quick chargeability and providing high image density and image quality even at a high-speed image formation in a high temperature/high humidity environment, by using a combination of a polyester binder resin having specified acid and hydroxyl values and a specific azo iron compound. The toner is also provided with improved toner flowability and halftone image quality. These improvements are enhanced by increasing the circularity of the toner.

What is claimed is:

1. A toner, comprising: at least a binder resin, a colorant and an organometallic compound; wherein
said organometallic compound is an azo iron compound produced from a mono-azo compound of Formula (A) below: 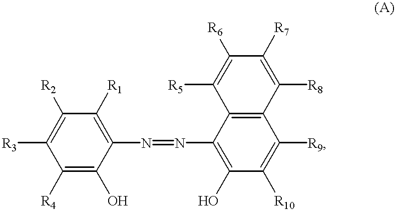
wherein R1-R10 independently denote hydrogen, halogen or alkyl with the proviso that one or more adjacent pairs among R1-R10 can be connected to form an aromatic or alicyclic ring, and at least one of R5-R10 is alkyl,
the binder resin comprises a polyester resin and has an acid value (Av) of 0.5 to 30 mgKOH/g and a hydroxyl value (OHv) of 1 to 50 mgKOH/g giving a ratio (Av/OHv) therebetween satisfying a relationship of:
0.05≦Av/OHv≦2.0.

2. The toner according to claim 1, wherein said azo iron compound is represented by Formula (B) below: 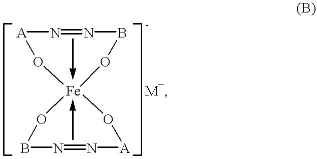
wherein A and B denote o-phenylene and 1,2naphthylene, respectively, each capable of having a substituent of halogen or alkyl with the proviso that the naphthylene residues have at least one alkyl group; and M⁺ denotes a cation of hydrogen, alkali metal, ammonium or organic ammonium.

3. A toner according to claim 1, wherein at least one of R5-R10 in the mono-azo compound (A) is an alkyl group having 4-12 carbon atoms.

4. A toner according to claim 1, wherein at least one of R5-R10 in the mono-azo compound (A) is an alkyl group having 6-10 carbon atoms.

5. A toner according to claim 3, wherein at least one of R5-R10 in the mono-azo compound (A) is a tertiary alkyl group having 4-12 carbon atoms.

6. A toner according to claim 4, wherein at least one of R5-R10 in the mono-azo compound (A) is a tertiary alkyl group having 6-10 carbon atoms.

7. A toner according to claim 3, wherein at least one of R5-R10 in the mono-azo compound (A) is an alkyl group having 6-10 carbon atoms and including at least 2 alkyl groups in its side chains.

8. A toner according to claim 4, wherein at least one of R5-R10 in the mono-azo compound (A) is an alkyl group having 6-10 carbon atoms and including at least 3 alkyl group in its side chains.

9. A toner according to claim 3, wherein R7 in the mono-azo compound (A) is an alkyl group having 4-12 carbon atoms.

10. A toner according to claim 4, wherein R7 in the mono-azo compound (A) is an alkyl group having 6-10 carbon atoms.

11. A toner according to claim 9, wherein R7 in the mono-azo compound (A) is a tertiary alkyl group having 4-12 carbon atoms.

12. A toner according to claim 10, wherein R7 in the mono-azo compound (A) is a tertiary alkyl group having 6-10 carbon atoms.

13. A toner according to claim 9, wherein R7 in the mono-azo compound (A) is an alkyl group having 4-12 carbon atoms and including at least 2 alkyl groups in its side chains.

14. A toner according to claim 10, wherein R7 in the mono-azo compound (A) is an alkyl group having 6-10 carbon atoms including at least 3 alkyl groups in its side chains.

15. The toner according to claim 1, wherein the azo iron compound is contained in an amount of 0.1-10 wt. parts per 100 wt. parts of the binder resin.

16. The toner according to claim 1, wherein the binder resin has an acid value (Av) of 0.5 to 20 mgKOH/g and a hydroxyl value (OHv) of 5 to 40 mgKOH/g giving a ratio (Av/OHv) therebetween satisfying:
0.05≦Av/OHv≦1.0.

17. The toner according to claim 1, wherein the binder resin h as an acid v alue (Av) of 0.5 to 10 mgKOH/g and a hydroxyl value (OHv) of 10 to 40 mgKOH/g giving a ratio (Av/OHv) therebetween satisfying:
0.05≦Av/OHv≦1.0.

18. The toner according to claim 1, wherein the toner has a weight-average particle size X in a range of 5-12 μm; and contains at least 90% by number of particles satisfying a circularity Ci according to formula (1) below of at least 0.900 with respect to particles of 3 μm or larger therein,
Ci=L₀/L (1),
wherein L denotes a peripheral length of a projection image of an individual particle, and L₀ denotes a peripheral length of a circle giving an identical area as the projection image; and the toner contains a number-basis percentage Y (%) of particles having Ci≧0.950 within particles of 3 μm or larger satisfying:
Y≧X^{-0.645}×exp5.51 (2).
